(19) United States
(12) Patent Application Publication
(10) Pub. No.: US 2008/0213511 A1
(43) Pub. Date: Sep. 4, 2008

(54) Optical compensation film, process for producing optical compensation film, polarizing plate and liquid crystal display device

(75) Inventors: Akira Ikeda, Minami-Ashigara-shi (JP); Mamoru Sakurazawa, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/010,289

(22) Filed: Jan. 23, 2008

(30) Foreign Application Priority Data
Jan. 23, 2007 (JP) 2007-012423
Mar. 16, 2007 (JP) 2007-068581

(51) Int. Cl. C09K 19/02; B32B 7/02; G02B 1/08

(52) U.S. Cl. 428/1.31; 428/212; 359/485

(57) ABSTRACT

An optical compensation film with optically biaxial properties, wherein the longer the wavelength is, the larger the wavelength dispersion of a retardation Re in an in-plane direction and a retardation Rth in a thickness direction against light in a visible light region is; the film contains at least one inorganic particle; a concentration of the inorganic particle in a film surface layer is from 0.05% to 1.0%; an average concentration of the inorganic particle in the film is from 0.01% to 0.3%; and the concentration of the inorganic particle in the surface layer is larger than the average concentration of the inorganic particle in the film.

### FIELD OF THE INVENTION

The present invention relates to an optical compensation film, a process for producing an optical compensation film, a polarizing plate and a liquid crystal display device.

### BACKGROUND OF THE INVENTION

A liquid crystal display device is widely utilized in monitors of personal computers and mobile appliances and applications for TV because of various advantages that downsizing and thinning can be achieved at low voltage and low electric power consumption. In such a liquid crystal display device, various modes are proposed depending upon an alignment state of liquid crystal molecules within a liquid crystal cell. A TN mode taking a twisted alignment state of about 90° toward an upper substrate from a lower substrate of the liquid crystal cell has hitherto been the mainstream.

In general, a liquid crystal display device is configured of an optical compensation sheet and a polarizer. The optical compensation sheet is used for the purpose of overcoming image coloration or enlarging a viewing angle, and a stretched birefringent film or a film having a liquid crystal coated on a transparent film is used. For example, JP-A-2003-344856 discloses a technology for applying an optical compensation sheet in which a discotic liquid crystal is coated, oriented and immobilized on a triacetyl cellulose film to a liquid crystal cell of a TN mode and enlarging a viewing angle. However, in a liquid crystal display device for television applications in which it is supposed that a person looks from various angles in a large-sized screen, demands for the viewing angle dependency are severe. Even by the foregoing method, these demands cannot be satisfied. For that reason, liquid crystal display devices different from the TN mode, for example, an IPS (in-plane switching) mode, an OCB (optically compensatory bend) mode and a VA (vertically aligned) mode are studied. In particular, the VA mode is watched as a liquid crystal display device for TV because it is high in contrast and relatively high in manufacture yield.

However, in the VA mode, though substantially complete black displaying can be achieved in a panel normal direction, there was involved a problem that when the panel is observed from an inclined direction, light leakage is generated, whereby a viewing angle becomes narrow. In order to solve this problem, it is proposed to enhance a viewing angle characteristic of the VA mode by using an optically biaxial retardation plate in which refractive indexes in three-dimensional directions of a film are different from each other (see, for example, JP-A-2003-344856).

However, the foregoing method merely reduces the light leakage in a certain wavelength region (for example, green light in the vicinity of 550 nm) but does not consider the light leakage in other wavelength regions (for example, blue light in the vicinity of 450 nm and red light in the vicinity of 650 nm). For that reason, for example, when the panel is observed from an inclined direction while achieving black displaying, there was a problem of so-called color shift that the panel is colored blue or red. As a measure for solving this problem, a method using two retardation films exhibiting specified wavelength dispersibility is proposed (see, for example, Japanese Patent No. 3648240 (corresponding to US2004/0239852A1)).

However, in the foregoing method, any achievement measure using other polymer than polycarbonates has not been found, and there were involved problems that a coefficient of photoelasticity is large and that working aptitude of a polarizing plate is inferior. Thus, improvements have been required.

On the other hand, a tendency for prices to fall of liquid crystal display device is proceeding, and a requirement to an enhancement of productivity of an optical compensation film is increasing much more.

From the viewpoint of an enhancement of productivity of an optical compensation film, slipperiness of the film surface is an important physical property. As a technology for enhancing slipperiness of the film surface, there is known a technology for enhancing productivity by adding a fine particle in a film. When a fine particle is added in the film, there is a problem that the haze becomes high, whereby a degree of transparency of the film is lowered. Therefore, it has been demanded to solve such a problem.

### SUMMARY OF THE INVENTION

Under the foregoing circumstances, the invention has been made, and a problem thereof is to provide an inexpensive film with high productivity, which has specified wavelength dispersibility such that the problem of color shift can be solved and which prevents an increase of haze. Another problem of the invention is to provide a liquid crystal display device which is able to display an image with high contrast in a viewing angle over a wide range and which is reduced with respect to color shift (change in tinting when viewed from an inclined direction), especially a liquid crystal display device of a VA mode.

Other problem of the invention is to provide an optical compensation film and a polarizing plate, each of which contributes to an enlargement of a viewing angle and a reduction in color shift depending upon a viewing angle of a liquid crystal display device, especially a liquid crystal display device of a VA mode.

The foregoing problems are solved by the following means.

[1] An optical compensation film with optically biaxial properties, wherein the longer the wavelength is, the larger the wavelength dispersion of a retardation Re in an in-plane direction and a retardation Rth in a thickness direction against light in a visible light region is; the film contains at least one kind of an inorganic particle; a concentration of the inorganic particle in a film surface layer is from 0.05% to 1.0%; an average concentration of the inorganic particle in the film is from 0.01% to 0.3%; and the concentration of the inorganic particle in the surface layer is larger than the average concentration of the inorganic particle in the film.
[2] The optical compensation film as set forth above in [1], wherein the optical compensation film contains at least one kind of a compound represented by the following formula (I).

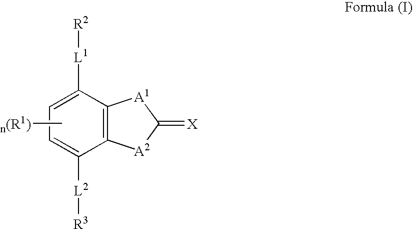

In the formula (I), L¹ and L² each independently represents a single bond or a divalent connecting group; A¹ and A² each independently represents a group selected from the group consisting of —O—, —NR—, —S— and —CO—; R represents a hydrogen atom or a substituent; R¹, R² and R³ each independently represents a substituent; X represents a non-metal atom belonging to the group 14 to the group 16 of a periodic table, and a hydrogen atom or a substituent may be bound to X; and n represents an integer of from 0 to 2.

[3] The optical compensation film as set forth above in [1] or [2], wherein the optical compensation film contains a cellulose acylate.
[4] The optical compensation film as set forth above in any one of [1] to [3], wherein the inorganic particle includes a silicon dioxide particle.
[5] The optical compensation film as set forth above in [2], wherein the optical compensation film is satisfied with the following expressions (a1) to (a6).

Re(548)>20 nm Expression (a1)

0.5<Nz<10 Expression (a2)

Re(446)/Re(548)≦1 Expression (a3)

1≦Re(628)/Re(548) Expression (a4)

Rth(446)/Rth(548)≦1 Expression (a5)

1≦Rth(628)/Rth(548) Expression (a6)

In the expressions (a1) to (a6), Re(λ) and Rth(λ) represent a retardation (unit: nm) in an in-plane direction and a retardation (unit: nm) in a thickness direction, respectively as measured when light having a wavelength of λ nm is made incident; and Nz=Rth(548)/Re(548)+0.5.

[6] The optical compensation film as set forth above in any one of [1] to [5], wherein the optical compensation film is a film formed by a co-casting method using a dope for surface layer and a dope for core layer and simultaneously extruding a surface layer, a core layer and a surface layer, and a concentration of the inorganic particle in the dope for surface layer is larger than a concentration of the inorganic particle in the dope for core layer.
[7] The optical compensation film as set forth above in any one of [1] to [5], wherein the optical compensation film is a stack film formed by using a dope for surface layer and a dope for core layer and successively casting them to stack and form a surface layer, a core layer and a surface layer, and a concentration of the inorganic particle in the dope for surface layer is larger than a concentration of the inorganic particle in the dope for core layer.
[8] An optical compensation film, wherein the compound represented by the formula (I) as set forth above in [2] is contained in the dope for core layer as set forth above in [6] or [7].
[9] A polarizing plate having the optical compensation film as set forth above in any one of [1] to [8].
[10] A liquid crystal display device having a pair of first and second polarizers; a liquid crystal cell disposed between the pair of polarizers; and the optical compensation film as set forth above in any one of [1] to [9] between the first polarizer and the liquid crystal cell.
[11] The liquid crystal display device as set forth above in [10], further having an optically anisotropic layer which is satisfied with the following expressions (b1) and (b2).

|Rth(548)/Re(548)|>10 Expression (b1)

Rth(628)−Rth(446)<0 Expression (b2)

[12] The liquid crystal display device as set forth above in [10] or [11], wherein the liquid crystal cell is a liquid crystal cell of a vertically aligned mode.

According to the invention, it is possible to provide a liquid crystal display device which is able to display an image with high contrast in a viewing angle over a wide range and which is reduced with respect to color shift (change in tinting when viewed from an inclined direction), especially a liquid crystal display device of a VA mode.

Also, according to the invention, it is possible to provide an optical compensation film and a polarizing plate, each of which contributes to an enlargement of a viewing angle and a reduction in color shift depending upon a viewing angle of a liquid crystal display device, especially a liquid crystal display device of a VA mode.

In particular, according to the invention, it is possible to provide an optical compensation film having the foregoing performances stably with high productivity.

### BRIEF DESCRIPTION OF THE DRAWINGS

FIG. 1 is a cross-sectional view for explaining one example of a process for producing an optical compensation film of the invention.

FIG. 2 is a diagrammatic schematic view of one example of a liquid crystal display device of the invention.

FIG. 3 is a view as used for explaining one example of an optical compensation mechanism of a liquid crystal display device of the invention on a Poincare sphere.

FIG. 4 is a view as used for explaining one example of an optical compensation mechanism of a liquid crystal display device of the invention on a Poincare sphere.

FIG. 5 is a view as used for explaining one example of an optical compensation mechanism of a liquid crystal display device of the invention on a Poincare sphere.

FIG. 6 is a cross-sectional schematic view of an example of a polarizing plate of the invention.

### DESCRIPTION OF REFERENCE NUMERALS AND SIGNS

1: Dope for surface layer
2: Dope for core layer
3: Co-casting Gieser
4: Casting support
11, 12: Polarizer
13: Liquid crystal cell
14: First optically anisotropic layer (optical compensation film of the invention)
15: Second optically anisotropic layer
16, 17: Outer passivation film

### DETAILED DESCRIPTION OF THE INVENTION

The terms “substantially orthogonal” or “substantially parallel” mean a range of strict angle ±10°.

In this specification, Re(λ) and Rth(λ) represent an in-plane retardation and a retardation in a thickness direction at a wavelength of λ, respectively. The Re(λ) is measured by making light having a wavelength of λ nm incident in a film normal direction in KOBRA 21ADH or WR (all of which are manufactured by Oji Scientific Instruments).

In the case where the film to be measured is represented by a uniaxial or biaxial refractive index ellipsoid, the Rth(λ) is calculated in the following manner.

With respect to the Rth(λ), the Re(λ) is measured in 6 points in total by forming an in-plane slow axis (judged by KOBRA 21ADH or WR) as an axis of tilt (rotating axis) (in the case where no slow axis exists, an arbitrary direction in the plane is formed as a rotating axis) and making light having a wavelength of λ nm incident from an inclined direction at a step of every 10 degrees to 50 degrees on one side from a normal direction to the film normal direction, and the Rth is calculated by KOBRA 21ADH or WR on the basis of a measured retardation value, a hypothesized value of average refractive index and an inputted film thickness value.

In the foregoing, in the case of a film having a direction where a retardation value is zero at a certain angle of inclination from the normal direction while forming the in-plane slow axis as a rotating axis, a retardation value at an angle of inclination larger than this angle of inclination is changed with a negative symbol, and the Rth is calculated by KOBRA 21ADH or WR.

The Rth can also be calculated according to the following numerical expressions (21) and (22) by forming the slow axis as an axis of tilt (rotating axis) (in the case where no slow axis exists, an arbitrary direction in the plane is formed as a rotating axis), measuring retardation values from two arbitrary inclined direction and making the measured values hypothesized value of average refractive index and an inputted film thickness value as a basis.

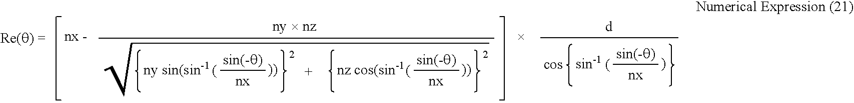

The foregoing Re(θ) represents a retardation value in a direction inclined at an angle of θ from the normal direction.

In the numerical expression (21), nx represents a refractive index in the slow axis direction in the plane; ny represents a refractive index in a direction orthogonal to nx in the plane; nz represents a refractive index in a direction orthogonal to nx and ny; and d represents a thickness of the film.

$$Rth = [ \frac{nx + ny}{2} - nz ] \times d \qquad Numerical Expression ( 22 )$$

In the case of a film which cannot be represented by a uniaxial or biaxial refractive index ellipsoid, namely a so-called optic axis-free film, the Rth(λ) is calculated in the following manner.

The Re(λ) is measured in 11 points by forming an in-plane slow axis (judged by KOBRA 21ADH or WR) as an axis of tilt (rotating axis) and making light having a wavelength of λ nm incident from an inclined direction at a step of every 10 degrees from −50 degrees to +50 degrees against the film normal direction, and the Rth is calculated by KOBRA 21ADH or WR on the basis of a measured retardation value, a hypothesized value of average refractive index and an inputted film thickness value.

In the foregoing measurement, as the hypothesized value of average refractive index, values described in Polymer Handbook (John Wiley & Sons, Inc.) and catalogues of various optical films can be employed. When a value of average refractive index is not known, it can be measured by an ABBE's refractometer. Values of average refractive index of major optical films are enumerated as follows: cellulose acylate (1.48), cycloolefin polymer (1.52), polycarbonate (1.59), polymethyl methacrylate (1.49) and polystyrene (1.59). By inputting such a hypothesized value of average refractive index and a thickness of the film, nx, ny and nz are computed by KOBRA 21ADH or WR. {Nz=(nx−nz)/(nx−ny)} is further calculated from the thus calculated nx, ny and nz.

In this specification, values of Re(446), Re(548), Re(628), Rth(446), Rth(548) and Rth(628) were determined in the following manner. That is, the measurement is made using three or more different wavelengths (for example, λ=446.0 nm, 547.6 nm, 628.8 nm and 748.7 nm) by a measurement analyzer, and Re and Rth are calculated from the respective wavelengths. These values are approximated according to the Cauchy's expression (up to the trinomial, Re=A+B/λ²+c/λ²), to obtain A, B and C values. According to this, the Re and Rth at a wavelength of λ are again plotted, from which can be then determined Re (446), Re(548), Re(628), Rth(446), Rth(548) and Rth(628) which are Re and Rth values at wavelengths of 446 nm, 548 nm and 628 nm, respectively.

The invention is hereunder described in more detail.

The invention is concerned with an optical compensation film with optically biaxial properties, which is characterized by containing at least one kind of a compound represented by the following formula (I) and at least one kind of an inorganic particle, with a concentration of the inorganic particle in a film surface layer being larger than an average concentration of the inorganic particle in the film.

By containing a retardation developing agent represented by the formula (I), it is possible to make the optical compensation film have a desired value of the retardation.

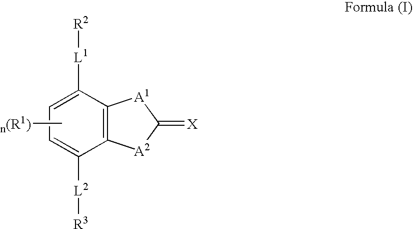

In the formula (I), L¹ and L² each independently represents a single bond or a divalent connecting group; A¹ and A² each independently represents a group selected from the group consisting of —O—, —NR—, —S— and —CO—; R represents a hydrogen atom or a substituent; R¹, R² and R³ each independently represents a substituent; X represents a non-metal atom belonging to the group 14 to the group 16 of a periodic table, and a hydrogen atom or a substituent may be bound to X; and n represents an integer of from 0 to 2.

In the invention, among the compounds represented by the foregoing formula (I), a compound represented by the following formula (II) is preferable.

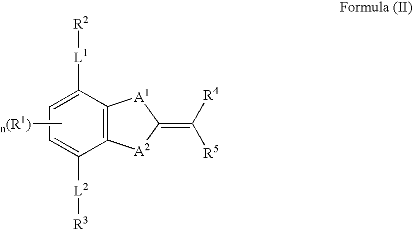

In the formula (II), L¹ and L² each independently represents a single bond or a divalent connecting group; A¹ and A² each independently represents a group selected from the group consisting of —O—, —NR—, —S— and —CO—; R represents a hydrogen atom or a substituent; R¹, R², R³, R⁴ and R⁵ each independently represents a substituent; and n represents an integer of from 0 to 2.

In the formula (I) or (II), preferred examples of the divalent connecting group represented by L¹ and L² include the following groups.

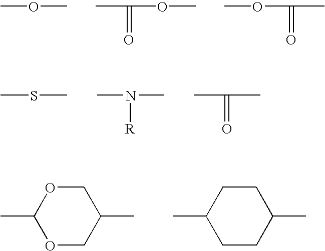

Of these, —O—, —COO— and —OCO— are more preferable.

In the formula (I) or (II), R¹ represents a substituent, and when plural R¹s exist, they are the same or different or may form a ring. Examples of the substituent which can be applied include the following groups.

That is, examples of the substituent include a halogen atom (for example, a fluorine atom, a chlorine atom, a bromine atom and an iodine atom); an alkyl group (preferably an alkyl group having from 1 to 30 carbon atoms; for example, a methyl group, an ethyl group, an n-propyl group, an isopropyl group, a tert-butyl group, an n-octyl group and a 2-ethylhexyl group); a cycloalkyl group (preferably a substituted or unsubstituted cycloalkyl group having from 3 to 30 carbon atoms; for example, a cyclohexyl group, a cyclopentyl group and a 4-n-dodecylcyclohexyl group); a bicycloalkyl group (preferably a substituted or unsubstituted bicycloalkyl group having from 5 to 30 carbon atoms, namely a monovalent group formed when one hydrogen atom is eliminated from a bicycloalkane having from 5 to 30 carbon atoms; for example, a bicyclo[1,2,2]heptan-2-yl group and a bicyclo[2,2,2]octan-3-yl group); an alkenyl group (preferably a substituted or unsubstituted alkenyl group having from 2 to 30 carbon atoms; for example, a vinyl group and an allyl group); a cycloalkenyl group (preferably a substituted or unsubstituted cycloalkenyl group having from 3 to 30 carbon atoms, namely a monovalent group formed when one hydrogen atom of a cycloalkene having from 3 to 30 carbon atoms is eliminated; for example, a 2-cyclopenten-1-yl group and a 2-cyclohexen-1-yl group); a bicycloalkenyl group (a substituted or unsubstituted bicycloalkenyl group, and preferably a substituted or unsubstituted bicycloalkenyl group having from 5 to 30 carbon atoms, namely a monovalent group formed when one hydrogen atom is eliminated from a bicycloalkene having one double bond; for example, a bicyclo[2,2,1]hept-2-en-1-yl group and a bicyclo[2,2,2]oct-2-en-4-yl group); an alkynyl group (preferably a substituted or unsubstituted alkynyl group having from 2 to 30 carbon atoms; for example, an ethynyl group and a propargyl group); an aryl group (preferably a substituted or unsubstituted aryl group having from 6 to 30 carbon atoms; for example, a phenyl group, a p-tolyl group and a naphthyl group); a heterocyclic group (preferably a monovalent group formed when one hydrogen atom is eliminated from a 5- or 6-membered substituted or unsubstituted, aromatic or non-aromatic heterocyclic compound, and more preferably a 5- or 6-membered aromatic heterocyclic group having from 3 to 30 carbon atoms; for example, a 2-furyl group, a 2-thienyl group, a 2-pyrimidinyl group and a 2-benzothiazolyl group); a cyano group; a hydroxyl group; a nitro group; a carboxyl group; an alkoxy group (preferably a substituted or unsubstituted alkoxy group having from 1 to 30 carbon atoms; for example, a methoxy group, an ethoxy group, an isopropoxy group, a tert-butoxy group, an n-octyloxy group and a 2-methoxyethoxy group); an aryloxy group (preferably a substituted or unsubstituted aryloxy group having from 6 to 30 carbon atoms; for example, a phenoxy group, a 2-methylphenoxy group, a 4-tert-butylphenoxy group, a 3-nitrophenoxy group and a 2-tetradecanoylaminophenoxy group); a silyloxy group (preferably a silyloxy group having from 3 to 20 carbon atoms; for example, a trimethylsilyloxy group and a tert-butyldimethylsilyloxy group); a heterocyclic oxy group (preferably a substituted or unsubstituted heterocyclic oxy group having from 2 to 30 carbon atoms; for example, a 1-phenyltetrazol-5-oxy group and a 2-tetrahydropyranyloxy group); an acyloxy group (preferably a formyloxy group, a substituted or unsubstituted alkylcarbonyloxy having from 2 to 30 carbon atoms or a substituted or unsubstituted arylcarbonyloxy group having from 6 to 30 carbon atoms; for example, a formyloxy group, an acetyloxy group, a pivaloyloxy group, a stearoyloxy group, a benzoyloxy group and a p-methoxyphenylcarbonyloxy group); a carbamoyloxy group (preferably a substituted or unsubstituted carbamoyloxy group having from 1 to 30 carbon atoms; for example, an N,N-dimethylcarbamoyloxy group, an N,N-diethylcarbamoyloxy group, a morpholinocarbonyloxy group, an N,N-di-n-octylaminocarbonyloxy group and an N-n-octylcarbamoyloxy group); an alkoxycarbonyloxy group (preferably a substituted or unsubstituted alkoxycarbonyloxy group having from 2 to 30 carbon atoms; for example, a methoxycarbonyloxy group, an ethoxycarbonyloxy group, a tert-butoxycarbonyloxy group and an n-octylcarbonyloxy group); an aryloxycarbonyloxy group (preferably a substituted or unsubstituted aryloxycarbonyloxy having from 7 to 30 carbon atoms; for example, a phenoxycarbonyloxy group, a p-methoxyphenoxycarbonyloxy group and a p-n-hexadecyloxyphenoxycarbonyloxy group); an amino group (preferably an amino group, a substituted or unsubstituted alkylamino group having from 1 to 30 carbon atoms or a substituted or unsubstituted anilino group having from 6 to 30 carbon atoms; for example, an amino group, a methylamino group, a dimethylamino group, an anilino group, an N-methyl-anilino group and a diphenylamino group); an acylamino group (preferably a formylamino group, a substituted or unsubstituted alkylcarbonylamino group having from 1 to 30 carbon atoms or a substituted or unsubstituted arylcarbonylamino group having from 6 to 30 carbon atoms; for example, a formylamino group, an acetylamino group, a pivaloylamino group, a lauroylamino group and a benzoylamino group); an aminocarbonylamino group (preferably a substituted or unsubstituted aminocarbonylamino group having from 1 to 30 carbon atoms; for example, a carbamoylamino group, an N,N-dimethylaminocarbonylamino group, an N,N-diethylaminocarbonylamino group and a morpholinocarbonylamino group); an alkoxycarbonylamino group (preferably a substituted or unsubstituted alkoxycarbonylamino group having from 2 to 30 carbon atoms; for example, a methoxycarbonylamino group, an ethoxycarbonylamino group, a tert-butoxycarbonylamino group, an n-octadecyloxycarbonylamino group and an N-methyl-methoxycarbonylamino group); an aryloxycarbonylamino group (preferably a substituted or unsubstituted aryloxycarbonylamino group having from 7 to 30 carbon atoms; for example, a phenoxycarbonylamino group, a p-chlorophenoxycarbonylamino group and an m-n-octyloxyphenoxycarbonylamino group); a sulfamoylamino group (preferably a substituted or unsubstituted sulfamoylamino group having from 0 to 30 carbon atoms; for example, a sulfamoylamino group, an N,N-dimethylaminosulfonylamino group and an N-n-octylaminosulfonylamino group); an alkyl- or arylsulfonylamino group (preferably a substituted or unsubstituted alkylsulfonylamino group having from 1 to 30 carbon atoms or a substituted or unsubstituted arylsulfonylamino group having from 6 to 30 carbon atoms; for example, a methylsulfonylamino group, a butylsulfonylamino group, a phenylsulfonylamino group, a 2,3,5-trichlorophenylsulfonylamino group and a p-methylphenylsulfonylamino group); a mercapto group; an alkylthio group (preferably a substituted or unsubstituted alkylthio group having from 1 to 30 carbon atoms; for example, a methylthio group, an ethylthio group and an n-hexadecylthio group); an arylthio group (preferably a substituted or unsubstituted arylthio group having from 6 to 30 carbon atoms; for example, a phenylthio group, a p-chlorophenylthio group and an m-methoxyphenylthio group); a heterocyclic thio group (preferably a substituted or unsubstituted heterocyclic thio group having from 2 to 30 carbon atoms; for example, a 2-benzothiazolylthio group and a 1-phenyltetrazol-5-ylthio group); a sulfamoyl group (preferably a substituted or unsubstituted sulfamoyl group having from 0 to 30 carbon atoms; for example, an N-ethylsulfamoyl group, an N-(3-dodecyloxypropyl)sulfamoyl group, an N,N-dimethylsulfamoyl group, an N-acetylsulfamoyl group, an N-benzoylsulfamoyl group and an N-(N′-phenylcarbamoyl)sulfamoyl group); a sulfo group; an alkyl- or arylsulfinyl group (preferably a substituted or unsubstituted alkylsulfinyl group having from 1 to 30 carbon atoms or a substituted or unsubstituted arylsulfinyl group having from 6 to 30 carbon atoms; for example, a methylsulfinyl group, an ethylsulfinyl group, a phenylsulfinyl group and a p-methylphenylsulfinyl group); an alkyl- or arylsulfonyl group (preferably a substituted or unsubstituted alkylsulfonyl group having from 1 to 30 carbon atoms or a substituted or unsubstituted arylsulfonyl group having from 6 to 30 carbon atoms; for example, a methylsulfonyl group, an ethylsulfonyl group, a phenylsulfonyl group and a p-methylphenylsulfonyl group); an acyl group (preferably a formyl group, a substituted or unsubstituted alkylcarbonyl group having from 2 to 30 carbon atoms or a substituted or unsubstituted arylcarbonyl group having from 7 to 30 carbon atoms; for example, an acetyl group and a pivaloylbenzoyl group); an aryloxycarbonyl group (preferably a substituted or unsubstituted aryloxycarbonyl group having from 7 to 30 carbon atoms; for example, a phenoxycarbonyl group, an o-chlorophenoxycarbonyl group, an m-nitrophenoxycarbonyl group and a p-tert-butylphenoxycarbonyl group); an alkoxycarbonyl group (preferably a substituted or unsubstituted alkoxycarbonyl group having from 2 to 30 carbon atoms; for example, a methoxycarbonyl group, an ethoxycarbonyl group, a tert-butoxycarbonyl group and an n-octadecyloxycarbonyl group); a carbamoyl group (preferably a substituted or unsubstituted carbamoyl group having from 1 to 30 carbon atoms; for example, a carbamoyl group, an N-methylcarbamoyl group, an N,N-dimethylcarbamoyl group, an N,N-di-n-octylcarbamoyl group and an N-(methylsulfonyl)carbamoyl group); an aryl or heterocyclic azo group (preferably a substituted or unsubstituted aryl azo group having from 6 to 30 carbon atoms or a substituted or unsubstituted heterocyclic azo group having from 3 to 30 carbon atoms; for example, a phenylazo group, a p-chlorophenylazo group and a 5-ethylthio-1,3,4-thiadiazol-2-ylazo group); an imide group (preferably an N-succinimide group or an N-phthalimide group); a phosphino group (preferably a substituted or unsubstituted phosphino group having from 2 to 30 carbon atoms, for example, a dimethylphosphino group, a diphenylphosphino group and a methylphenoxyphosphino group); a phosphinyl group (preferably a substituted or unsubstituted phosphinyl group having from 2 to 30 carbon atoms; for example, a phosphinyl group, a dioctyloxyphosphinyl group and a diethoxyphosphinyl group); a phosphinyloxy group (preferably a substituted or unsubstituted phosphinyloxy group having from 2 to 30 carbon atoms; for example, a diphenoxyphosphinyloxy group and a dioctyloxyphosphinyloxy group); a phosphinylamino group (preferably a substituted or unsubstituted phosphinylamino group having from 2 to 30 carbon atoms; for example, a dimethoxyphosphinylamino group and a dimethylaminophosphinylamino group); and a silyl group (preferably a substituted or unsubstituted silyl group having from 3 to 30 carbon atoms; for example, a trimethylsilyl group, a tert-butyldimethylsilyl group and a phenyldimethylsilyl group).

Among the foregoing substituents, those having a hydrogen atom may be one in which the hydrogen atom is eliminated and substituted therefor with any of the foregoing groups. Examples of such a functional group include an alkycarbonylaminosulfonyl group, an arylcarbonylaminosulfonyl group, an alkylsulfonylaminocarbonyl group and an arylsulfonylaminocarbonyl group. Specific examples thereof include a methylsulfonylaminocarbonyl group, a p-methylphenylsulfonylaminocarbonyl group, an acetylaminosulfonyl group and a benzoylaminosulfonyl group.

R¹ is preferably a halogen atom, an alkyl group, an alkenyl group, an aryl group, a heterocyclic group, a hydroxyl group, a carboxyl group, an alkoxy group, an aryloxy group, an acyloxy group, a cyano group or an amino group, and more preferably a halogen atom, an alkyl group, a cyano group or an alkoxy group.

R² and R³ each independently represents a substituent. Examples of the substituent include those as in the foregoing R¹. R² and R³ are preferably a substituted or unsubstituted benzene ring or a substituted or unsubstituted cyclohexane ring, more preferably a substituted benzene ring or a substituted cyclohexane ring, and further preferably a benzene ring having a substituent at the 4-position thereof or a cyclohexane ring having a substituent at the 4-position thereof.

R⁴ and R⁵ each independently represents a substituent. Examples of the substituent include those as in the foregoing R¹. R⁴ and R⁵ are preferably an electron withdrawing substituent having a Hammett's substituent constant σₚ value of larger than 0, and more preferably an electron withdrawing substituent having a Hammett's substituent constant σₚ value of from 0 to 1.5. Examples of such a substituent include a trifluoromethyl group, a cyano group, a carbonyl group and a nitro group. R⁴ and R⁵ may be taken together to form a ring.

The Hammett's substituent constants σₚ and σₘ are commentated in detail in, for example, INAMOTO, Naoki, Hametto Soku—Kozo to Hannosei—(Hammett's Rule—Structure and Reactivity—) (Maruzen Co., Ltd.); The Chemical Society of Japan Ed., Shin Jikken Kagaku Koza (New Courses in Experimental Chemistry) 14: Syntheses and Reactions of Organic Compounds V, page 2605 (Maruzen Co., Ltd.); NAKAYA, Tadao, Riron Yuki Kagaku Kaisetsu (Commentary on Theoretical Organic Chemistry), page 217 (Tokyo Kagaku Dojin Co., Ltd.); and Chemical Review, Vol. 91, pages 165 to 195 (1991).

A¹ and A² each independently represents a group selected from the group consisting of —O—, —NR— (wherein R represents a hydrogen atom or a substituent), —S— and —CO—, and preferably —O—, —NR— (wherein R represents a substituent, examples of which include those as in the foregoing R¹) or —S—.

X represents a non-metal atom belonging to the group 14 to the group 16 of a periodic table, provided that a hydrogen atom or a substituent may be bound to X. X is preferably ═O, ═S, ═NR or ═C(R)R (wherein R represents a substituent, examples of which include those as in the foregoing R¹).

n represents an integer of from 0 to 2, and preferably 0 or 1.

Specific examples of the compound represented by the formula (I) or (II) are given below, but it should not be construed that examples of the foregoing Re developing agent are limited to the following specific examples. With respect to the following compounds, Illustrative Compound (λ) is expressed by a numeral in a parenthesis unless otherwise indicated.

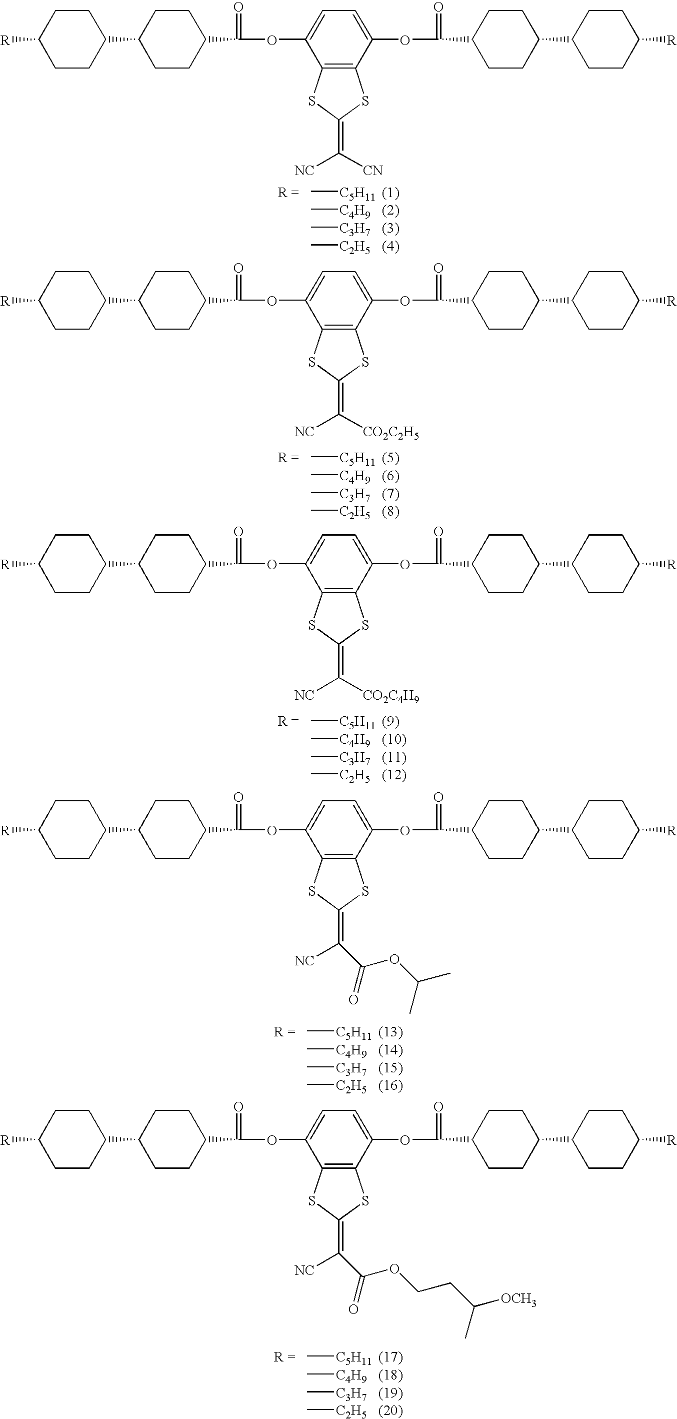

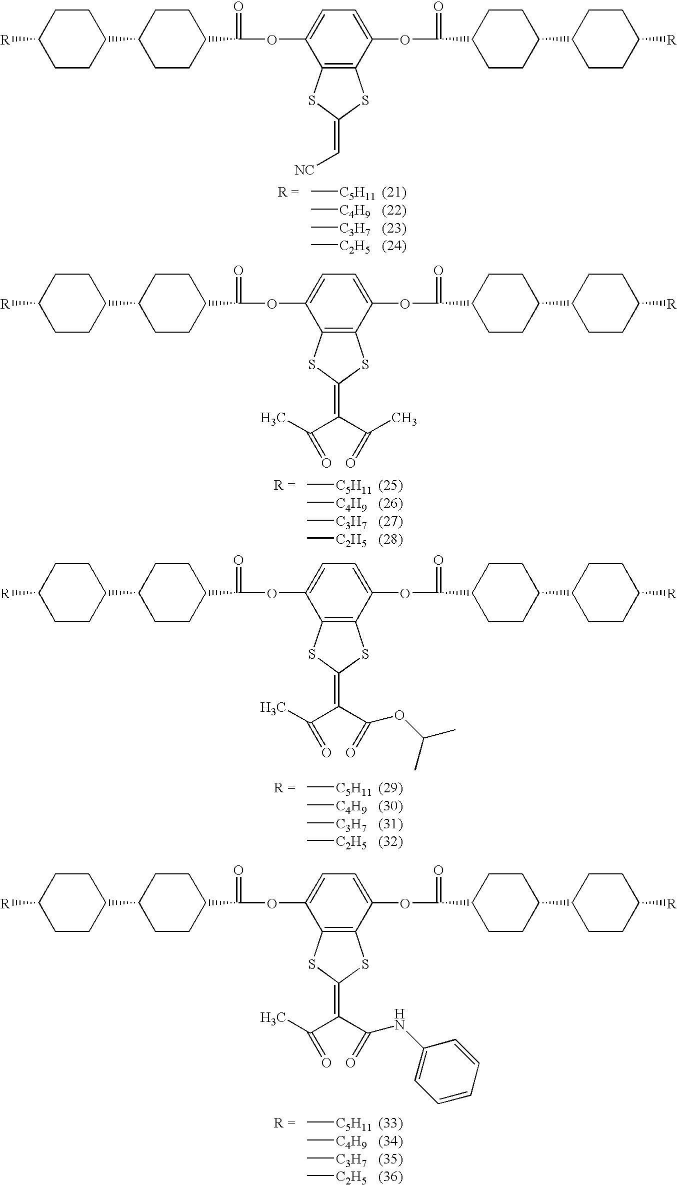

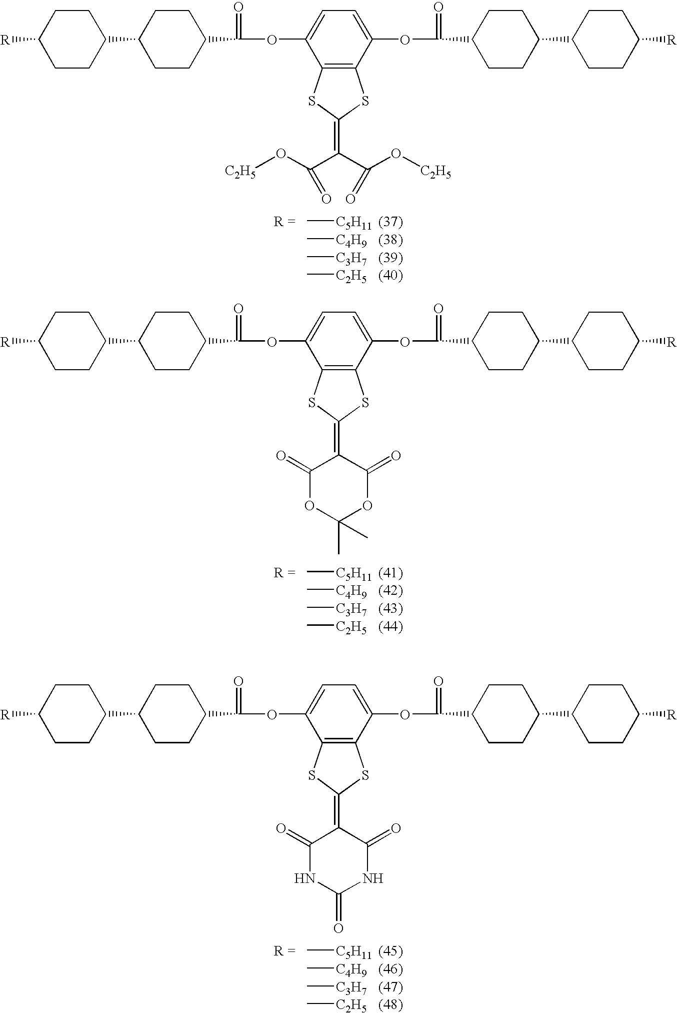

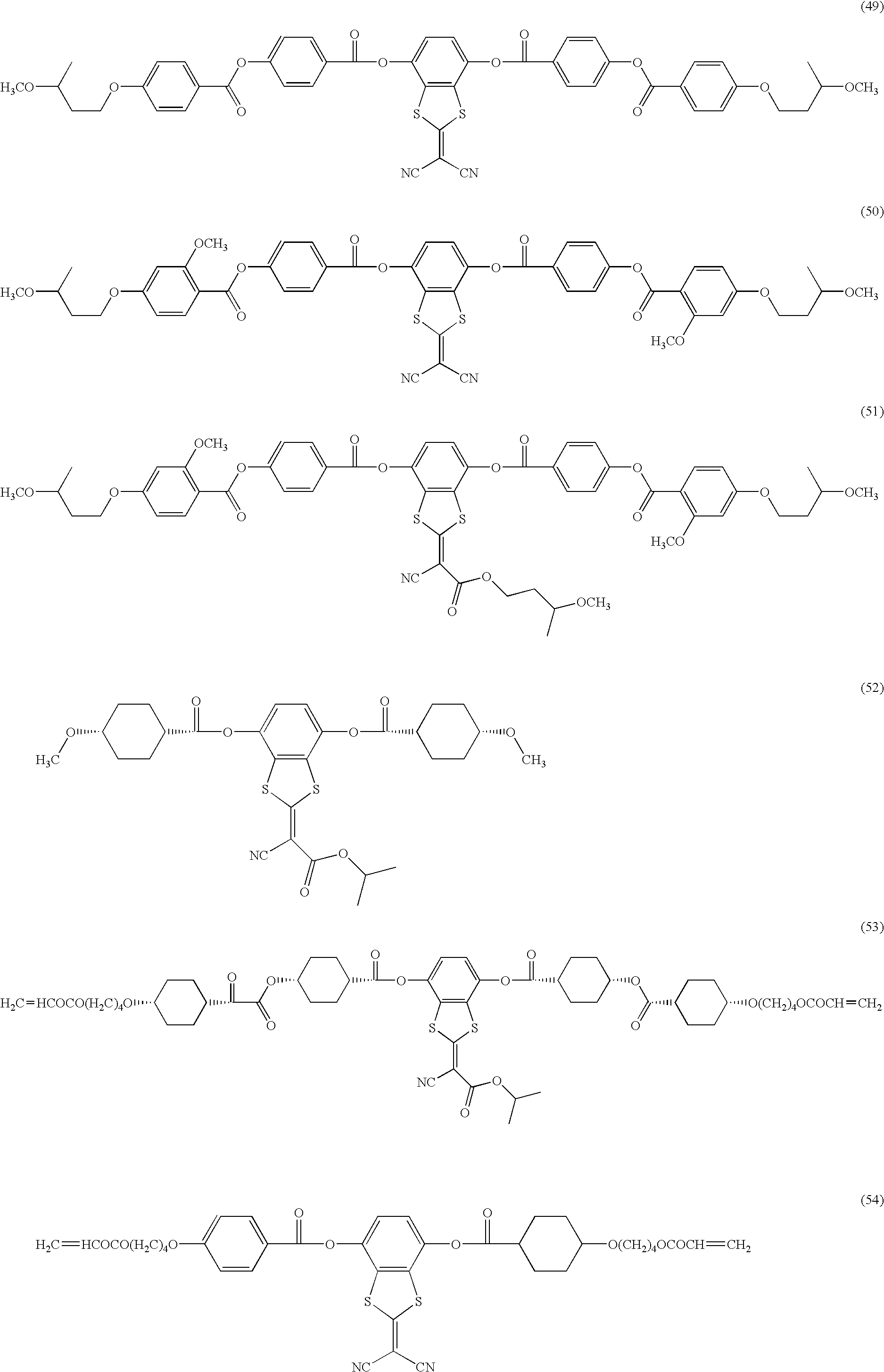

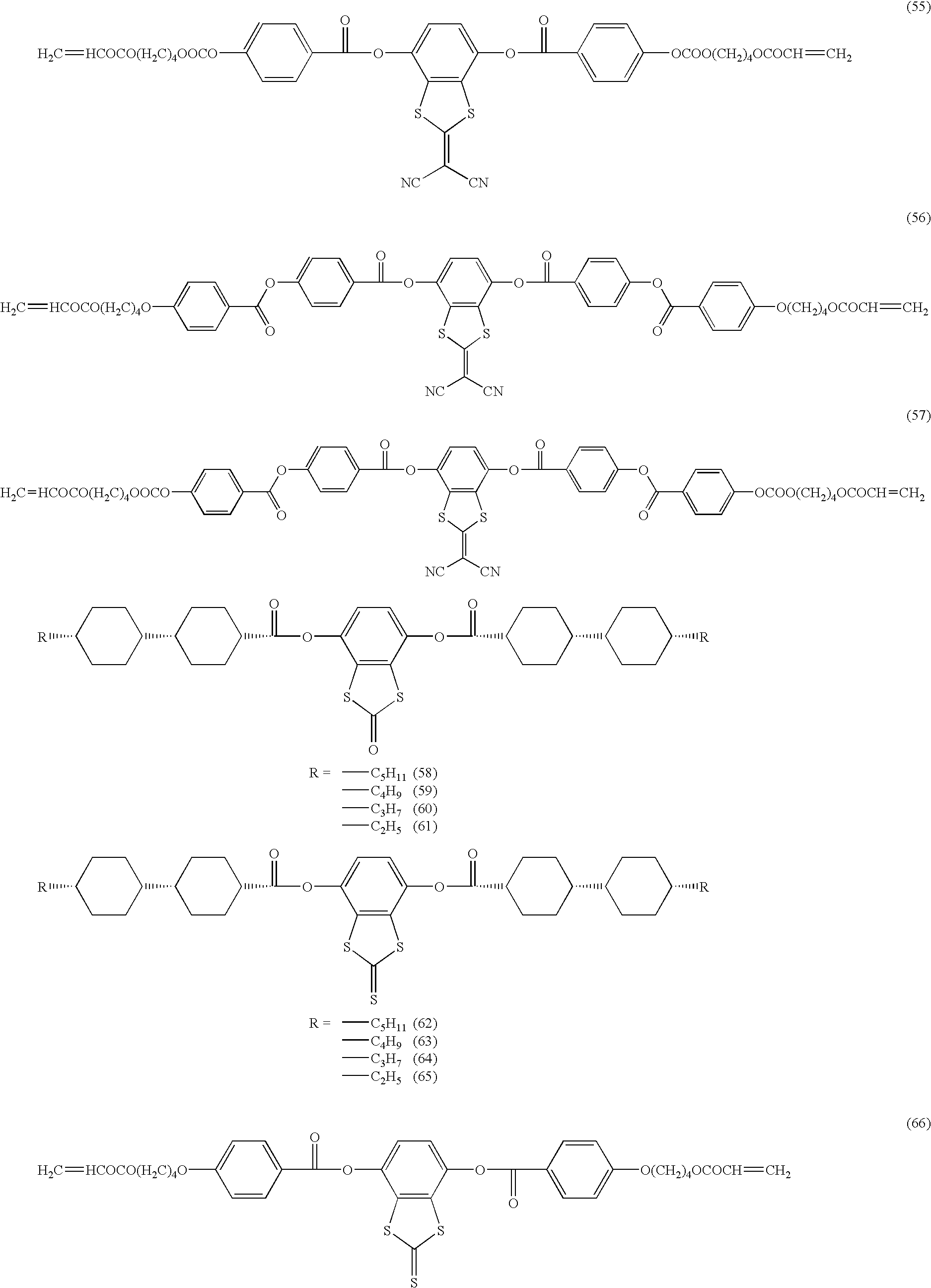

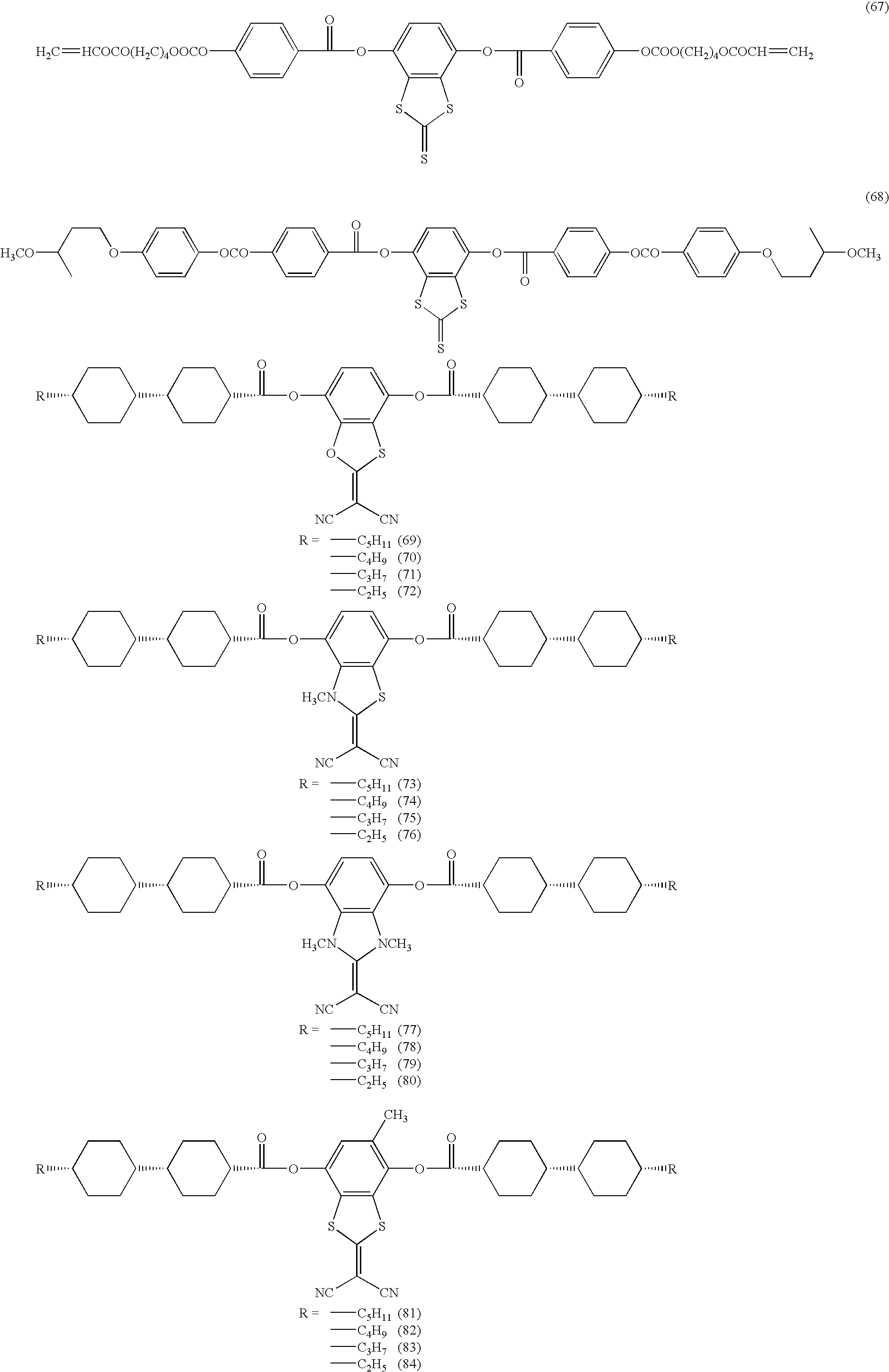

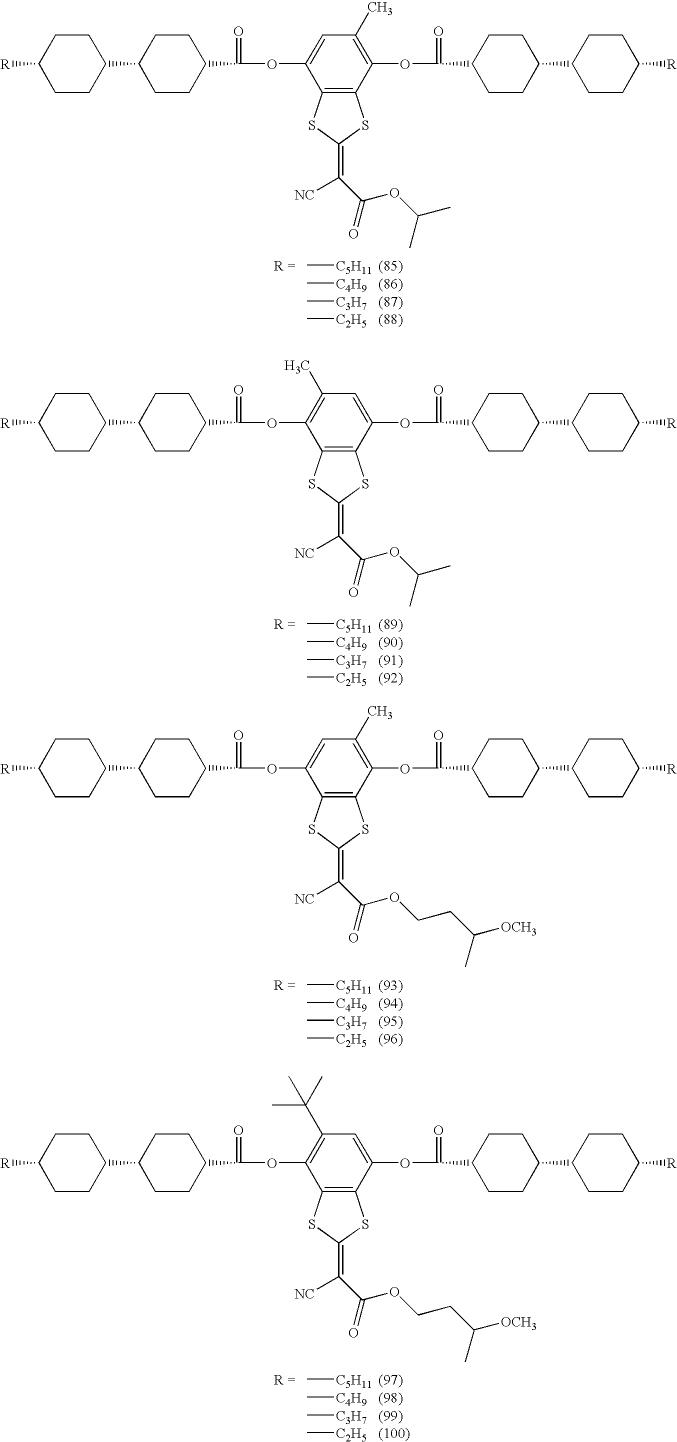

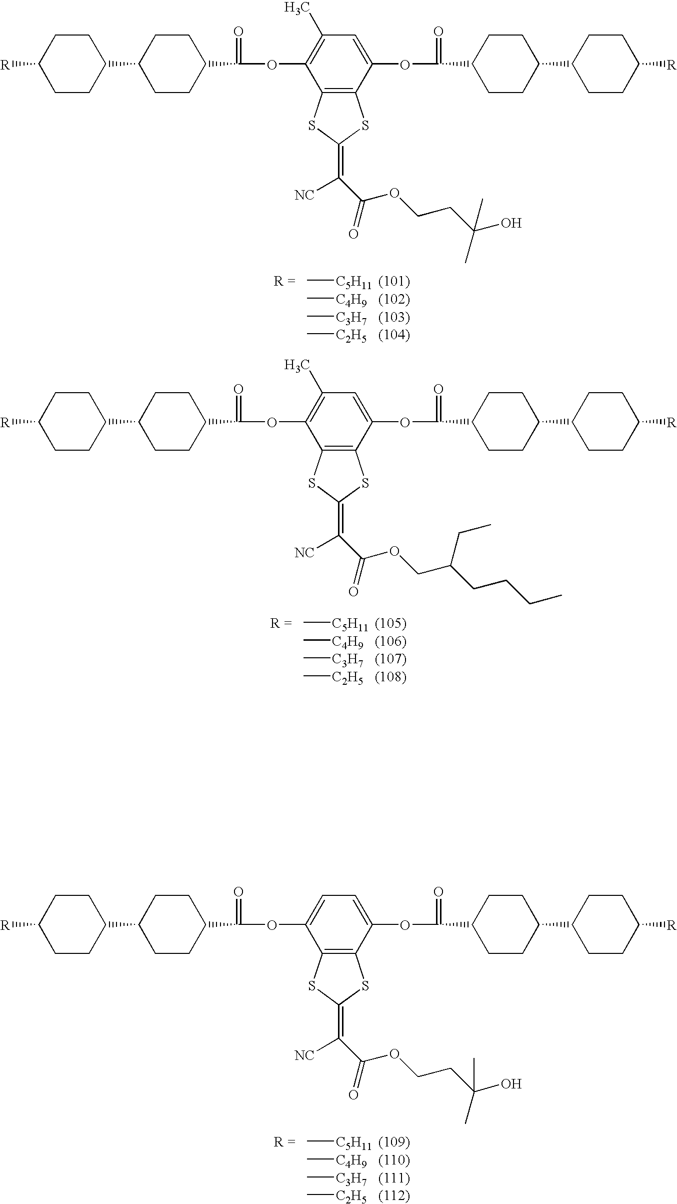

The synthesis of the compound represented by the foregoing formula (I) or (II) can be carried out by referring to a known method. For example, Illustrative Compound (I) can be synthesized according to the following scheme.

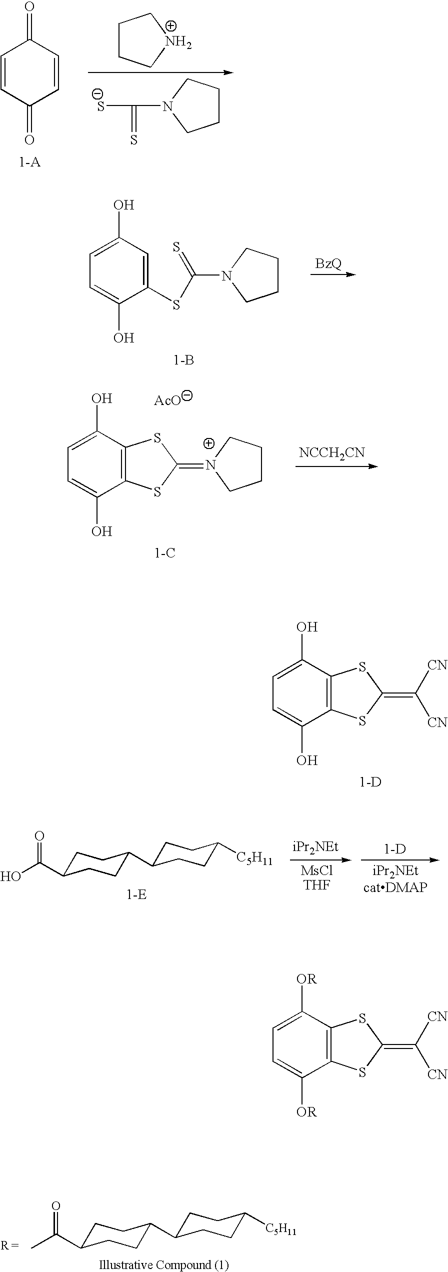

In the foregoing scheme, the synthesis from Compound (1-A) to Compound (1-D) can be carried out by referring to a method as described in Journal of Chemical Crystallography, 27(9), pages 515 to 526 (1997).

Furthermore, as illustrated in the foregoing scheme, Illustrative Compound (1) can be obtained by adding methanesulfonic acid chloride to a solution of Compound (1-E) in tetrahydrofuran; adding dropwise N,N-diisopropylethylamine and stirring the mixture; further adding N,N-diisopropyl-ethylamine; adding dropwise a solution of Compound (1-D) in tetrahydrofuran; and then adding dropwise a solution of N,N-dimethylaminopyridine (DMAP) in tetrahydrofuran.

The optical compensation film of the invention can contain at least kind of the compound represented by the formula (I) and may use a combination of plural kinds thereof.

The content of the compound represented by the formula (I) is preferably from 0.1 to 30 parts by mass, more preferably from 0.5 to 20 parts by mass, further preferably from 1 to 12 parts by mass, and most preferably from 1 to 5 parts by mass relative to the polymer for forming a film.

By using the compound represented by the formula (I), the retardation Re in an in-plane direction and the retardation Rth in a film thickness direction are made close to a desired value, respectively; and furthermore, the wavelength dispersion characteristic of each of Re and Rth at each wavelength becomes satisfactory. Especially, in the invention, by a stretching operation of the foregoing optical film, not only its Re development is assisted, but the wavelength dispersion of Re can be chiefly made close to a desired value of range. It can be considered that what the wavelength dispersion of Re can be made close to a desired value of range is caused due to the matter that when the compound represented by the formula (I) is aligned in a stretching direction in the film, a transition dipole moment of absorption in an ultraviolet region can be made substantially orthogonal in the stretching direction, whereby the wavelength dispersibility of Re relatively increases on a long wave side.

It is preferable that the compound represented by the formula (I) develops a liquid crystal phase in a temperature range of from 100° C. to 300° C., and more preferably from 120° C. to 200° C. The liquid crystal phase is preferably a columnar phase, a nematic phase or a smectic phase, and more preferably a nematic phase or a smectic phase.

In using the compound represented by the formula (I), there may be a possibility of the generation of a minute separation structure or an increase of haze depending upon the kinds of other co-existing compounds and additives. Especially, when an inorganic particle is used, it is preferable that the both are separated and used.

In preparing the optical film of the invention, it is preferable to use a compound represented by the following formula (a) as an additive together with the compound represented by the foregoing formula (I).

Ar¹-L²-X-L³-Ar² Formula (a)

In the foregoing formula (a), Ar¹ and Ar² each independently represents an aromatic group; L² and L³ each independently represents a divalent connecting group selected from an —O—CO— group and a —CO—O— group; and X represents a 1,4-cyclohexylene group, a vinylene group or an ethynylene group.

In this specification, the aromatic group includes an aryl group (aromatic hydrocarbon group), a substituted aryl group, an aromatic heterocyclic group and a substituted aromatic heterocyclic group.

The aryl group and the substituted aryl group are more preferable than the aromatic heterocyclic group and the substituted aromatic heterocyclic group. The hetero ring of the aromatic heterocyclic group is generally unsaturated. The aromatic hetero ring is preferably a 5-membered ring, a 6-membered ring or a 7-membered ring, and more preferably a 5-membered ring or a 6-membered ring. The aromatic hetero ring generally has a maximum number of double bonds. As the hetero atom, a nitrogen atom, an oxygen atom and a sulfur atom are preferable, with a nitrogen atom and a sulfur atom being more preferable.

Examples of the aromatic ring of the aromatic group include a benzene ring, a furan ring, a thiophene ring, a pyrrole ring, an oxazole ring, a thiazole ring, an imidazole ring, a triazole ring, a pyridine ring, a pyrimidine ring and a pyrazine ring. Of these, a benzene ring is especially preferable.

Examples of the substituent of the substituted aryl group and the substituted aromatic heterocyclic ring include a halogen atom (for example, F, Cl, Br and I), a hydroxyl group, a carboxyl group, a cyano group, an amino group, an alkylamino group (for example, a methylamino group, an ethylamino group, a butylamino group and a dimethylamino group), a nitro group, a sulfo group, a carbamoyl group, an alkylcarbamoyl group (for example, an N-methylcarbamoyl group, an N-ethylcarbamoyl group and an N,N-dimethylcarbamoyl group), a sulfamoyl group, an alkylsulfamoyl group (for example, an N-methylsulfamoyl group, an N-ethylsulfamoyl group and an N,N-dimethylsulfamoyl group), a ureido group, an alkylureido group (for example, an N-methylureido group, an N,N-dimethylureido group and an N,N,N′-trimethylureido group), an alkyl group (for example, a methyl group, an ethyl group, a propyl group, a butyl group, a pentyl group, a heptyl group, an octyl group, an isopropyl group, a sec-butyl group, a t-amyl group, a cyclohexyl group and a cyclopentyl group), an alkenyl group (for example, a vinyl group, an allyl group and a hexenyl group), an alkynyl group (for example, an ethynyl group and a butynyl group), an acyl group (for example, a formyl group, an acetyl group, a butyryl group, a hexanoyl group and a lauryl group), an acyloxy group (for example, an acetoxy group, a butyryloxy group, a hexanoyloxy group and a lauryloxy group), an alkoxy group (for example, a methoxy group, an ethoxy group, a propoxy group, a butoxy group, a pentyloxy group, a heptyloxy group and an octyloxy group), an aryloxy group (for example, a phenoxy group), an alkoxycarbonyl group (for example, a methoxycarbonyl group, an ethoxycarbonyl group, a propoxycarbonyl group, a butoxycarbonyl group, a pentyloxycarbonyl group and a heptyloxycarbonyl group), an aryloxycarbonyl group (for example, a phenoxycarbonyl group), an alkoxycarbonylamino group (for example, a butoxycarbonylamino group and a hexyloxycarbonylamino group), an alkylthio group, (for example, a methylthio group, an ethylthio group, a propylthio group, a butylthio group, a pentylthio group, a heptylthio group and an octylthio group), an arylthio group (for example, a phenylthio group), an alkylsulfonyl group (for example, a methylsulfonyl group, an ethylsulfonyl group, a propylsulfonyl group, a butylsulfonyl group, a pentylsulfonyl group, a heptylsulfonyl group and an octylsulfonyl group), an amido group (for example, an acetamido group, a butylamido group, a hexylamido group and a laruylamido group) and a non-aromatic heterocyclic group (for example, a morpholino group and a pyradinyl group).

As the substituent of the substituted aryl group and the substituted aromatic heterocyclic group, a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group are preferable.

The alkyl moiety and the alkyl group of the alkylamino group, the alkoxycarbonyl group, the alkoxy group and the alkylthio group may further have a substituent. Examples of the substituent of the alkyl moiety and the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an acylamino group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. As the substituent of the alkyl moiety and the alkyl group, a halogen atom, a hydroxyl group, an amino group, an alkylamino group, an acyl group, an acyloxy group, an acylamino group, an alkoxycarbonyl group and an alkoxy group are preferable.

In the formula (a), L² and L³ each independently represents a divalent connecting group selected from —O—CO—, —CO—O— and a combination thereof.

In the formula (a), X represents a 1,4-cyclohexylene group, a vinylene group or an ethynylene group.

Specific examples of the compound represented by the formula (a) are given below.

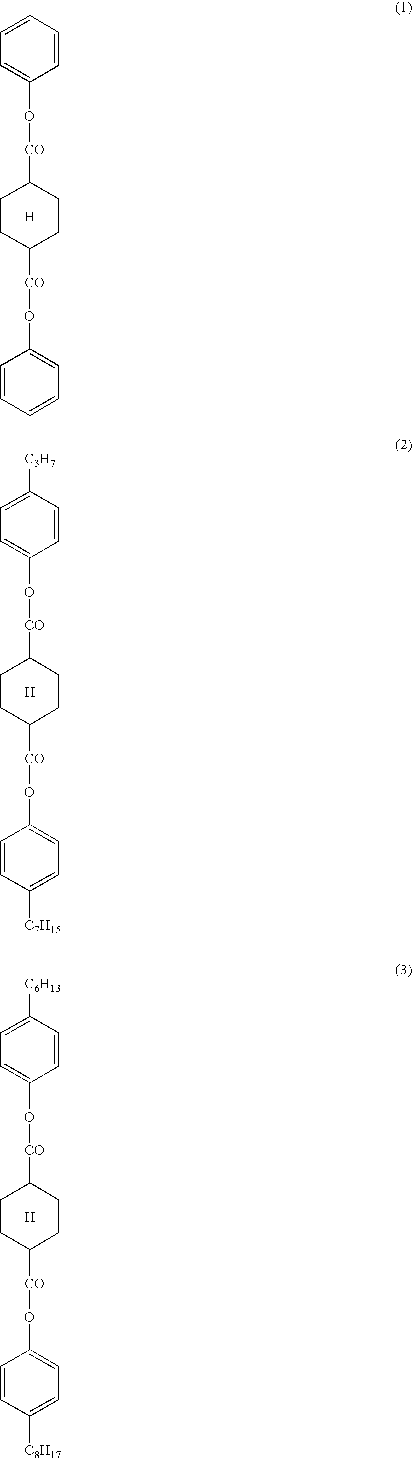

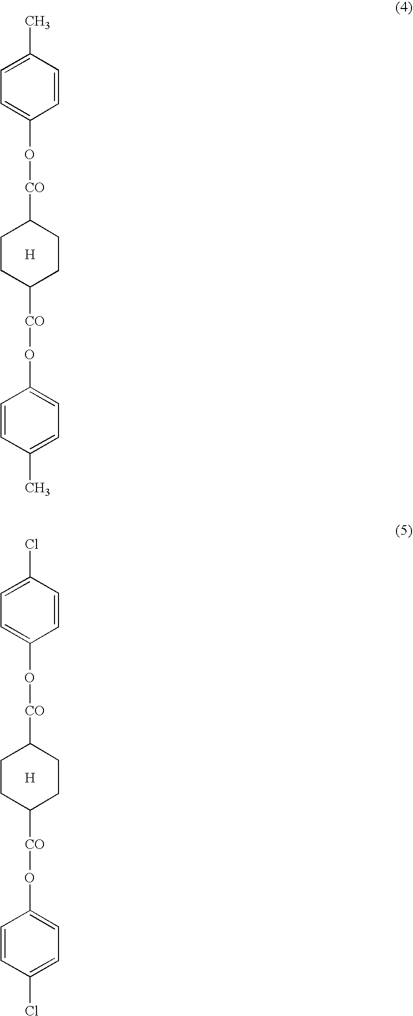

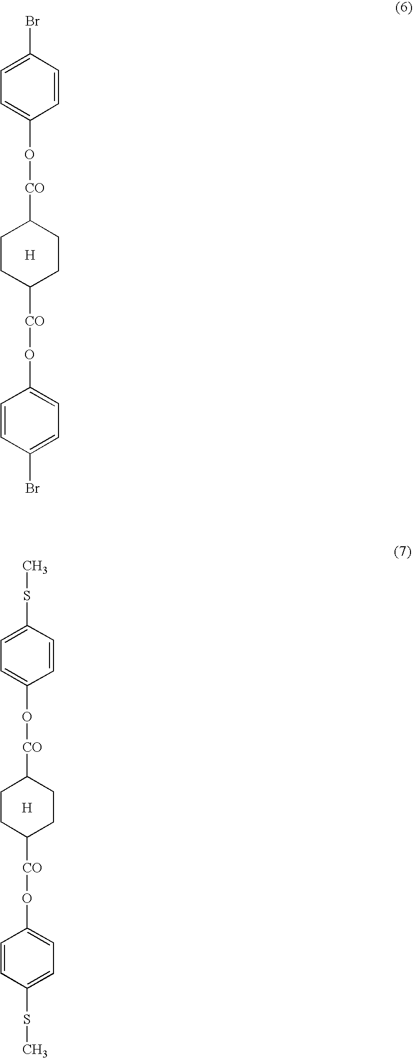

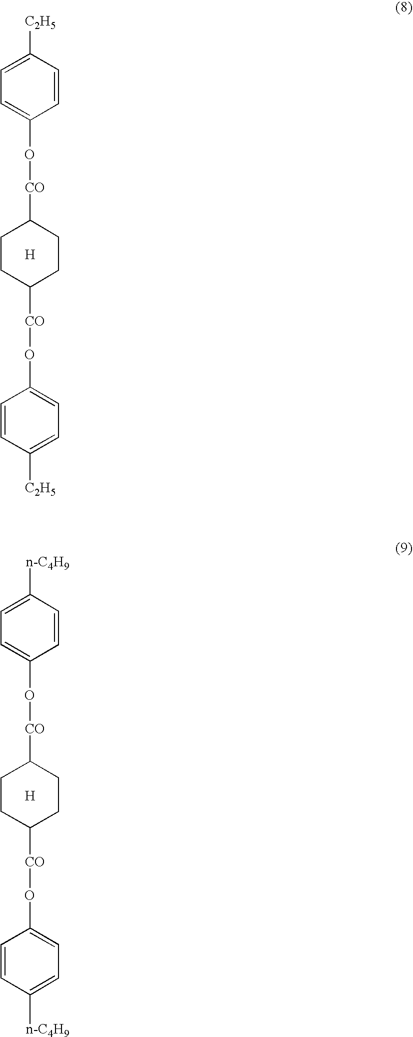

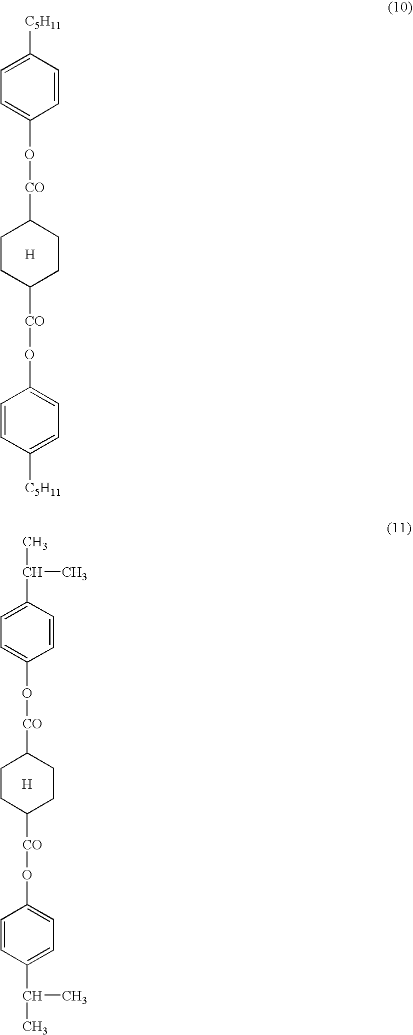

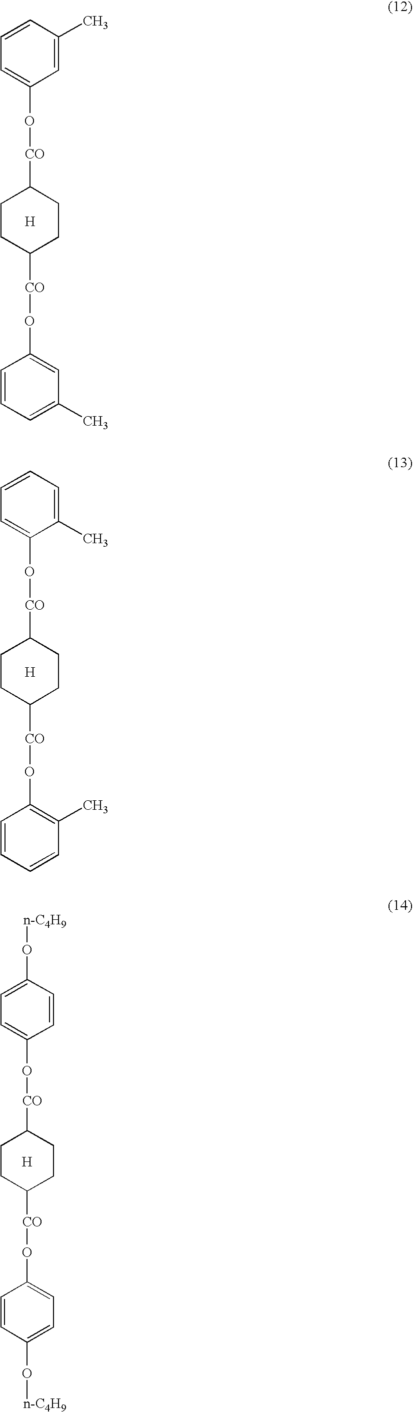

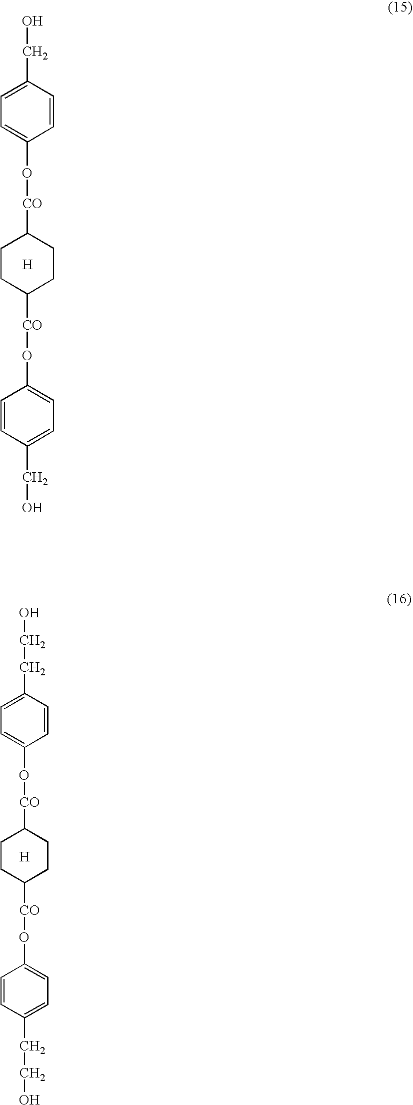

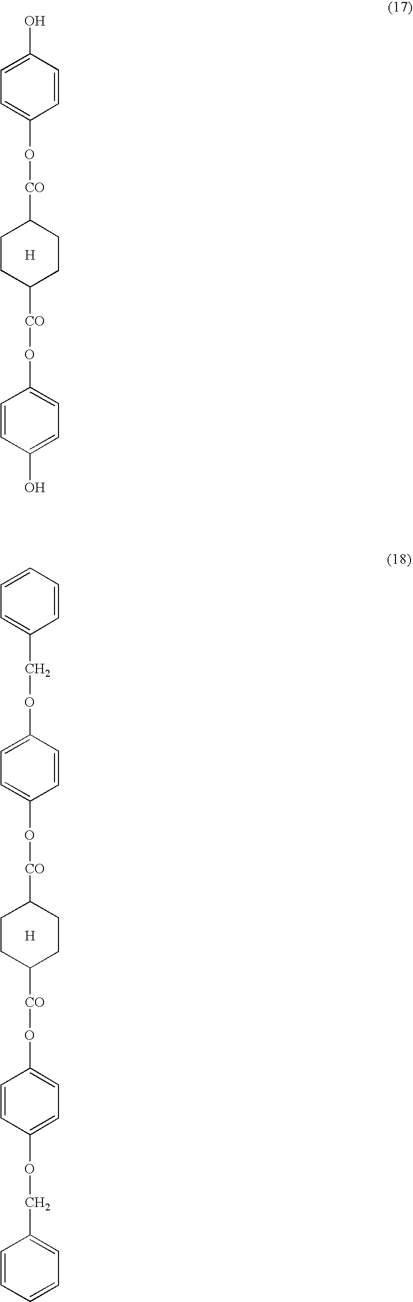

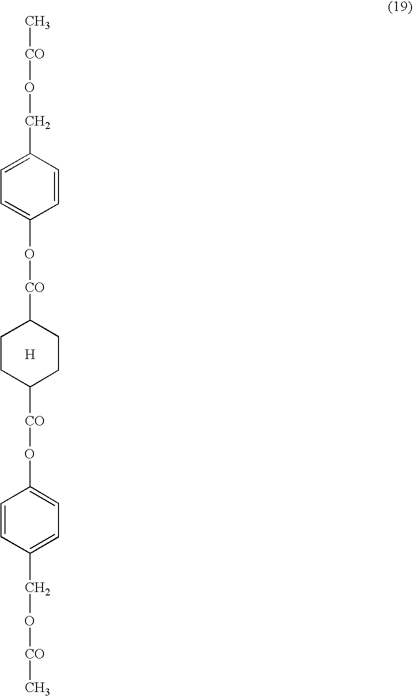

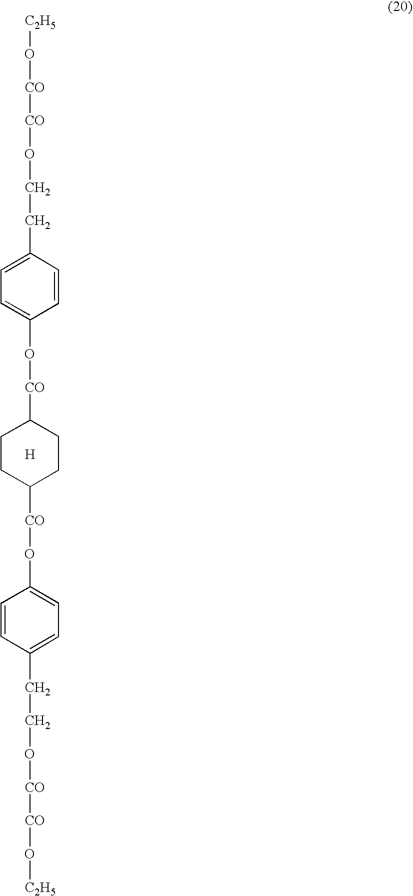

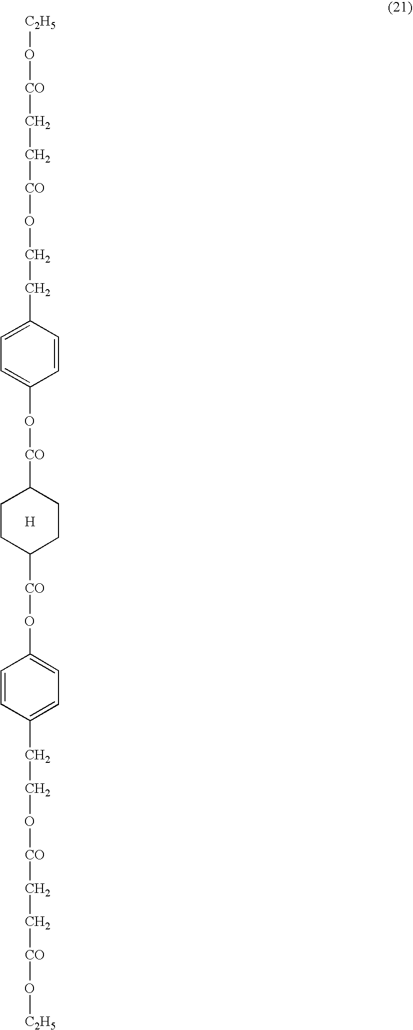

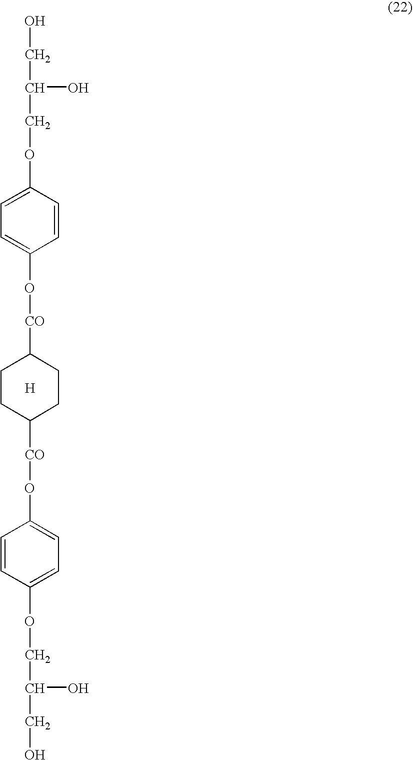

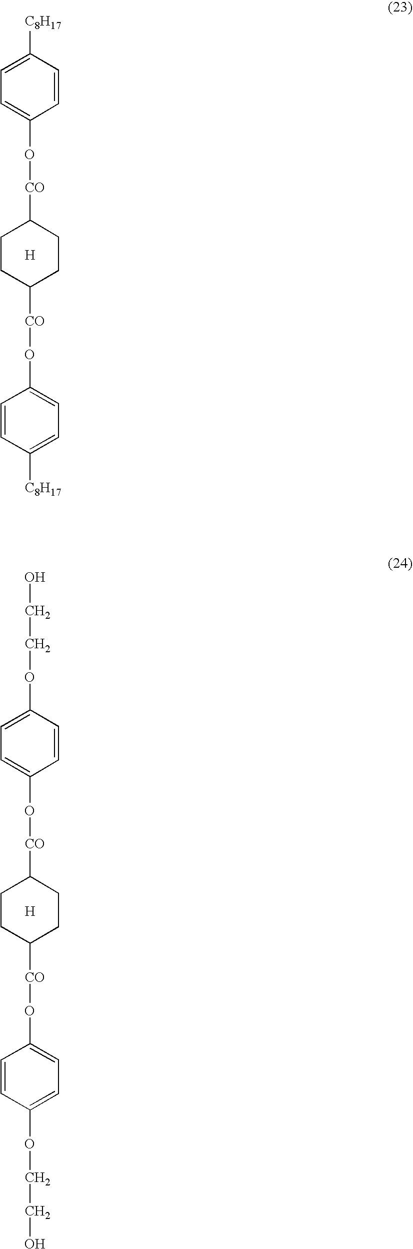

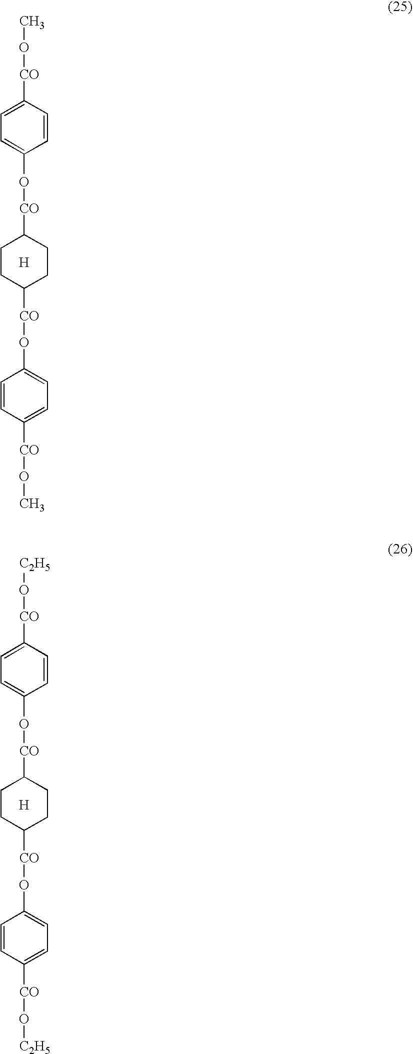

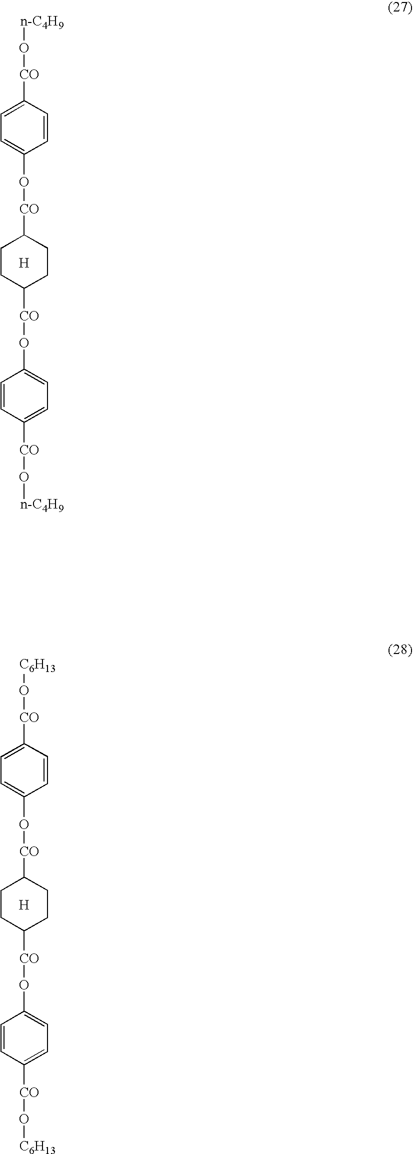

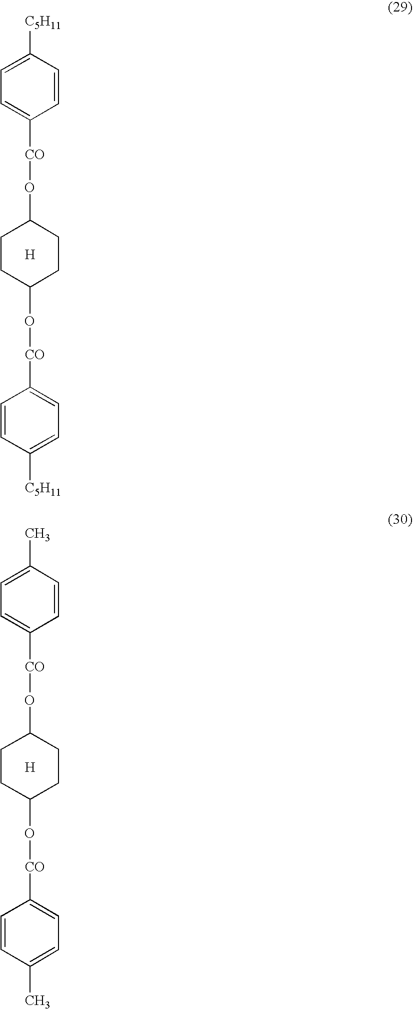

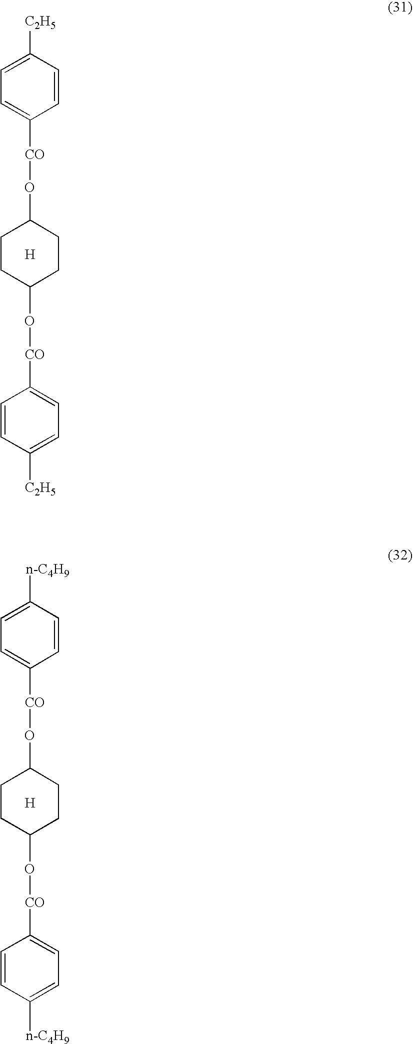

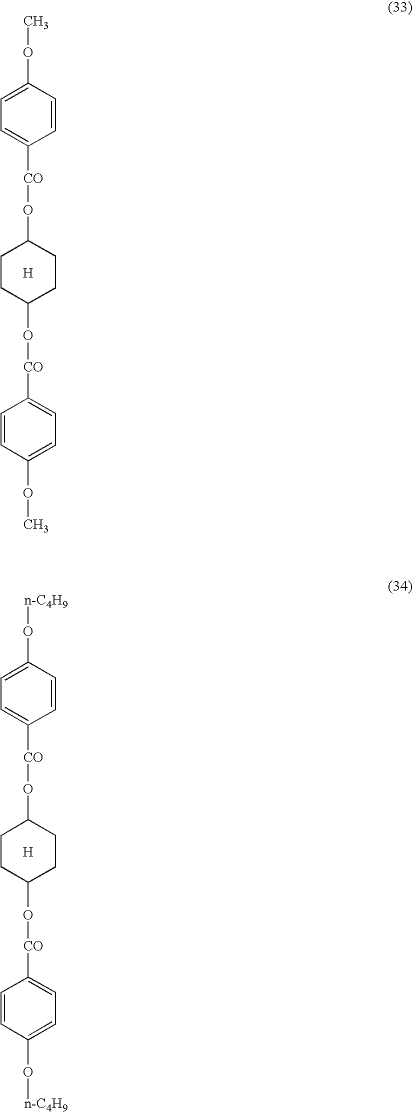

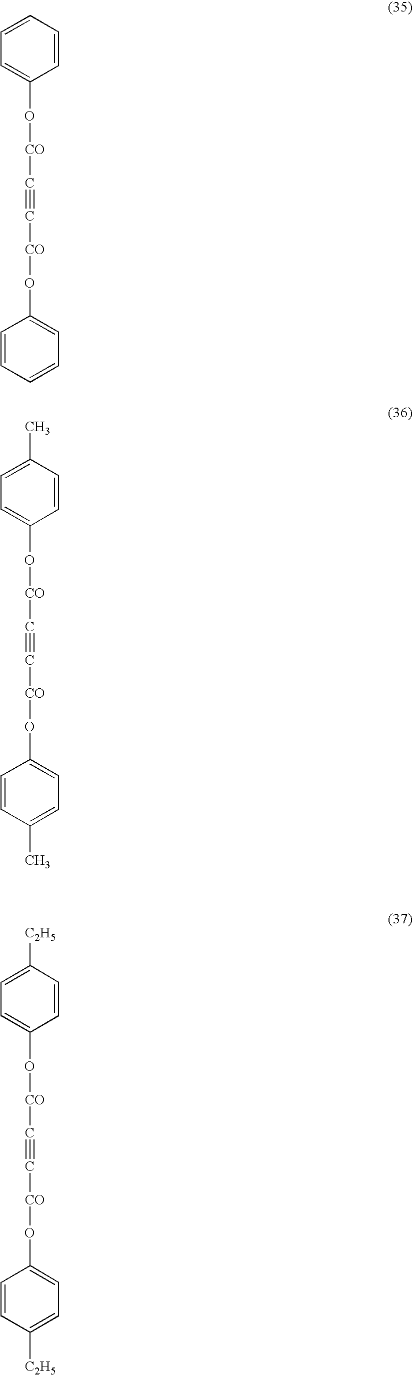

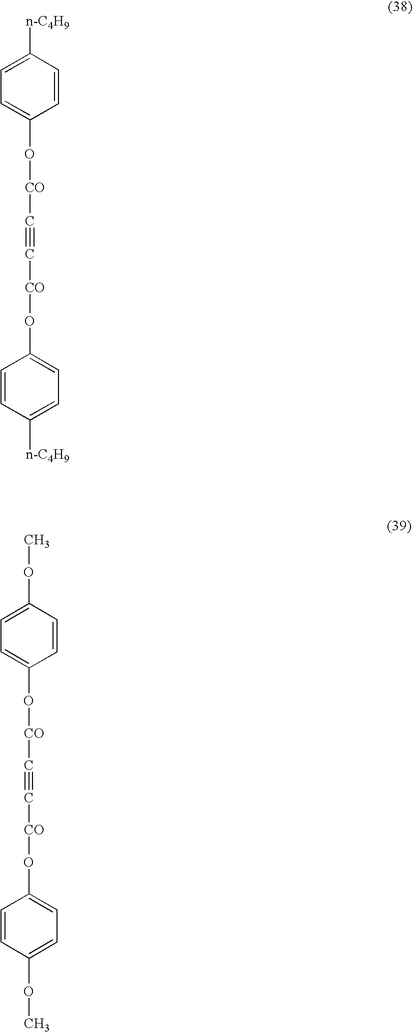

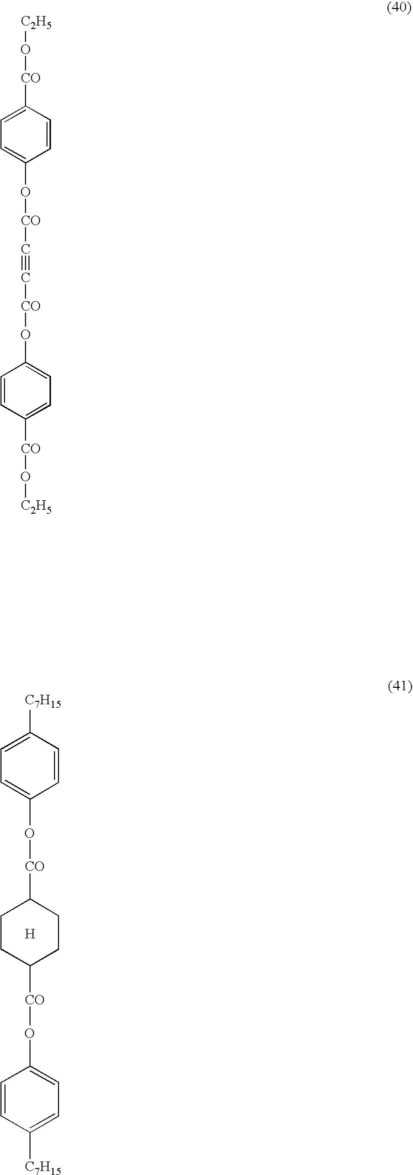

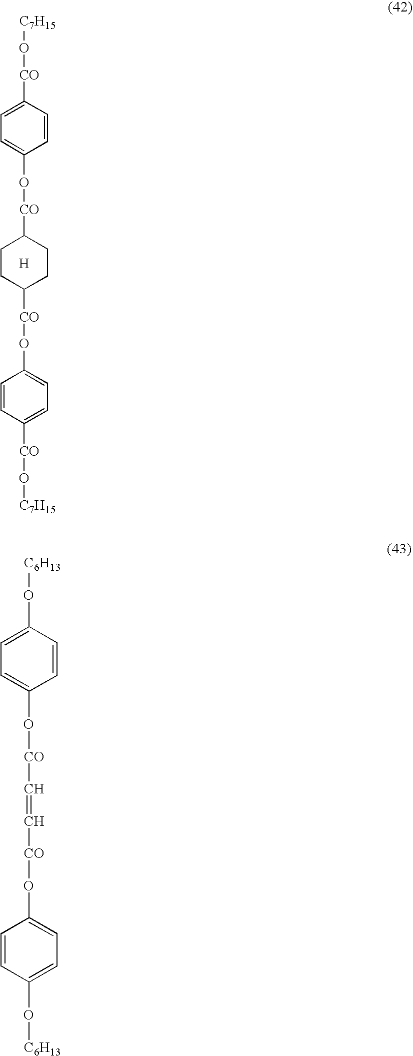

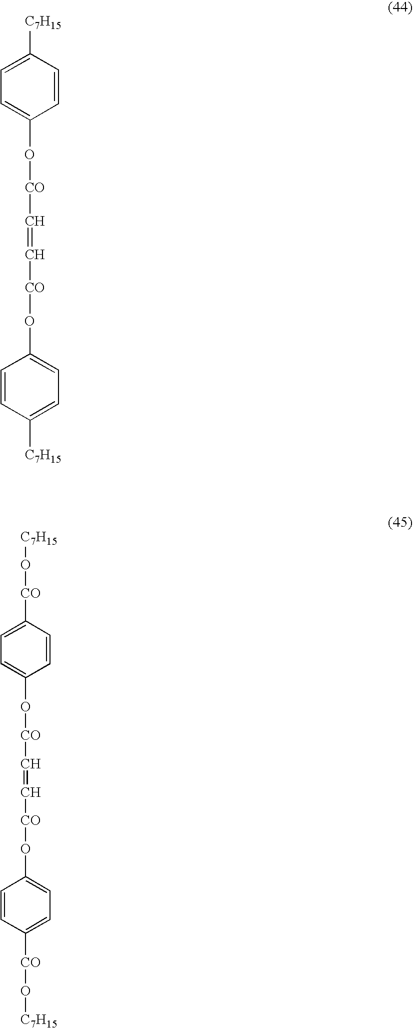

Each of Specific Examples (1) to (34), (41) and (42) has two asymmetric carbon atoms at the 1-position and 4-position of the cyclohexane ring. However, since each of Specific Examples (1), (4) to (34), (41) and (42) has a molecular structure of a symmetric meso form, an optical isomer (with optical activity) is not present, and only geometric isomers (a trans form and a cis form) are present. A trans form (1-trans) and a cis form (1-cis) of Specific Example (1) are shown below.

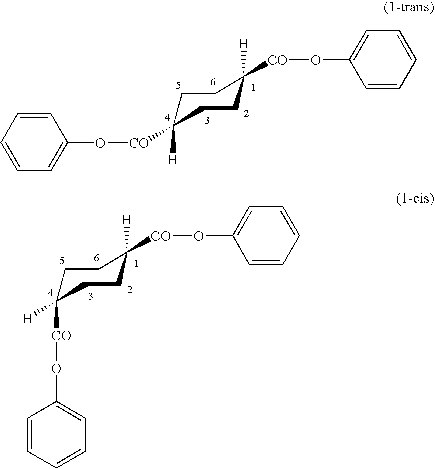

As described previously, it is preferable that the rod-like compound has a linear molecular structure. For that reason, the trans form is more preferable than the cis form.

Each of Specific Examples (2) and (3) has optical isomers in addition to geometric isomers (four kinds of isomers in total). With respect to the geometric isomers, the trans form is similarly more preferable than the cis form. With respect to the optical isomers, there is no particular superiority or inferiority, and all of D and L isomers and a racemate are useful.

In each of Specific Examples (43) to (45), there are a trans form and a cis form with respect to the vinylene bond present in the center. The trans form is more preferable than the cis form for the same reason.

### [Inorganic Particle]

For the purpose of preventing squeak from occurring, the optical compensation film of the invention is characterized by containing an inorganic particle. The inorganic particle which can be used in the invention is hereunder described.

Examples of the inorganic particle which is used in the invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. With respect to the inorganic particle, one containing silicon is preferable in view of the matter that the haze is low, and silicon dioxide is especially preferable.

As the particle of silicon dioxide, one having an average particle size of primary particle of not more than 20 nm and an apparent specific gravity of 70 g/L or more is preferable. One having a small average particle size of primary particle as from 5 to 16 nm is more preferable because it is able to reduce the haze of the film. The apparent specific gravity is preferably from 90 to 200 g/L, and more preferably from 100 to 200 g/L. What the apparent specific gravity is large is preferable because a dispersion with a high concentration can be prepared, and the haze and the coagulated material are improved.

In the case where a silicon dioxide particle is used as a matting agent, its use amount is preferably from 0.01 to 0.3 parts by mass based on 100 parts by mass of the cellulose acylate-containing polymer component.

Such an inorganic particle usually forms a secondary particle having an average particle size of from 0.1 to 3.0 μm. The secondary particle exists as a coagulated material of the primary particle in the film and forms irregularities of from 0.1 to 3.0 μm on the film surface. The average particle size of the secondary particle is preferably 0.2 μn or more and not more than 1.5 μm, more preferably 0.4 μm or more and not more than 1.2 μm, and most preferably 0.6 μm or more and not more than 1.1 μm. When the average particle size is not more than 1.5 μm, the haze does not become excessively strong. Also, when it is 0.2 μm or more, an effect for preventing squeak is sufficiently exhibited, and therefore, such is preferable.

The primary or secondary particle size of the particle is defined in terms of a diameter of a circle which touches externally the particle upon observation of the particle in the film by a scanning electron microscope. Also, by changing the place and observing 200 particles, its average value is defined as an average particle size.

As the particle of silicon dioxide, commercially available products such as AEROSIL R972, AEROSIL R972V, AEROSIL R974, AEROSIL R812, AEROSIL 200, AEROSIL 200V, AEROSIL 300, AEROSIL R202, AEROSIL OX50 and AEROSIL TT600 (all of which are manufactured by Nippon Aerosil Co., Ltd.) can be used. The particle of zirconium oxide is commercially available as a trade name, for example, AEROSIL R976 and AEROSIL R811 (all of which are manufactured by Nippon Aerosil Co., Ltd.), and these products can be used.

Of these, AEROSIL 200V and AEROSIL R972V are especially preferable because they are a particle of silicon dioxide having an average particle size of primary particle of not more than 20 nm and an apparent specific gravity of 70 g/L or more and have a large effect for reducing a coefficient of friction while keeping a turbidity of the optical film low.

Furthermore, the optical compensation film of the invention is characterized in that a concentration of the inorganic particle in the film surface layer is larger than an average concentration of the inorganic particle in the film.

As a result of investigations made by the present inventors, it has been found that when the compound represented by the formula (I) is used in combination with the inorganic particle, there is a possibility that haze is generated depending upon the condition.

Then, as a result of extensive and intensive investigations, it has been found that by making the concentration of the inorganic particle in the film surface layer larger than the average concentration of the inorganic particle in the film, the haze can be reduced.

The average concentration of the inorganic particle in the film surface layer as referred to herein is an average concentration of the inorganic particle in the range falling within 3 μm in a film thickness direction from the film surface; and the average concentration of the inorganic particle in the film as referred to herein is an average concentration of the inorganic particle in the whole of the film.

In the invention, the average concentration of the inorganic particle in the film surface layer is preferably from 0.05% to 1.0%, and more preferably from 0.1% to 0.3%. Also, the average concentration of the inorganic particle in the film is preferably from 0.01% to 0.3%, and more preferably from 0.01% to 0.1%.

Here, the average concentration of the inorganic particle in the film surface layer can be specifically measured in the following method.

### (Measurement Method of Concentration of Inorganic Particle in Film Surface Layer)

The concentration of the inorganic particle in the film surface layer can be determined by measuring photoelectron spectra in the film surface layer and achieving calculation on the basis of an intensity ratio of the thus obtained signals of an atom derived from the inorganic particle and a carbon atom. In the measurement of photoelectron spectra, ESCA-3400, manufactured by Shimadzu Corporation can be used.

A more specific method is hereunder described with respect to the case of using a silicon dioxide particle as the inorganic particle. With respect to each of the films, its surface is shaven by an ion etching unit attached to the foregoing ESCA-3400 (condition: ion gun, voltage: 2 kV, current: 20 mA), and an intensity ratio Si2p/C1s of signals which are able to be assigned to silicon and carbon, respectively is measured.

The foregoing measurement is carried out at intervals of about 1 μm towards the film thickness direction from the film surface, and the concentration of the silicon dioxide inorganic particle in the film surface layer can be calculated from an average value of values of Si2p/C1s in the range falling within 3 μm from the film surface.

Furthermore, as other method for measuring the concentration of the inorganic particle in the film surface layer, a method for directly counting the inorganic particle number by a method of observing a film cross-section by SEM (scanning electron microscope) can be exemplified. In that case, the concentration of the inorganic particle number in the foregoing film surface layer can be calculated from a value per unit region of the inorganic particle number as counted in the film surface layer. In all of these cases, it becomes possible to calculate the concentration of the silicon dioxide inorganic particle by previously preparing a calibration curve data in a sample.

As a specific method for making the inorganic particle in the optical compensation film have the foregoing distribution, a method for preparing a film by co-casting can be exemplified. This method will be described later in detail.

Also, the optical compensation film of the invention is characterized in that it is an optical compensation film with biaxial properties.

Here, what the optical compensation film has biaxial properties refers to the case where nx, ny and nz of the optical compensation film (wherein nx represents a refractive index in a slow axis direction in a plane; ny represents a refractive index in a direction orthogonal to nx in a plane; and nz represents a refractive index in a direction orthogonal to nx and ny) are different from each other. In the case of the invention, {nx>ny>nz} is more preferable.

The matter that the optical compensation film of the invention exhibits an optical characteristic with biaxial properties is an important characteristic in view of reducing the problem of color shift in the case of observing a liquid crystal display device, especially a liquid crystal display device of a VA mode from an inclined direction.

### [Optical Performance of Optical Compensation Film of the Invention]

The optical film of the invention is an optical compensation film with biaxial properties, wherein the longer the wavelength is, the larger the wavelength dispersion of a retardation Re in an in-plane direction and a retardation Rth in a thickness direction against light in a visible light region is; the film contains at least one kind of an inorganic particle; and a concentration of the inorganic particle in a film surface layer is larger than an average concentration of the inorganic particle in the film.

Here, the light in a visible light region is specifically light having a wavelength of from 380 to 780 nm, and it is preferable that the optical compensation film has a characteristic that the longer the wavelength is, the larger the Re and Rth values (namely, reverse dispersibility) are.

According to this, it is possible to control the wavelength dispersibility of retardation of the optical compensation film at a desired pattern. In the invention, an absorption maximum of the liquid crystalline compound is preferably in the range of 200 nm or more and not more than 370 nm, more preferably 220 nm or more and not more than 350 nm, and most preferably 240 nm or more and not more than 330 nm.

By using such an optical compensation film in the liquid crystal display device of the invention, it is possible to more reduce tinting in the case of viewing the liquid crystal display device from an inclined direction.

The foregoing optical compensation film of the invention is preferably satisfied with the following expressions (a1) and (a2) and more preferably satisfied with the following expressions (a1)′ and (a2)′.

Re(548)>20 nm Expression (a1)

0.5<Nz<10 Expression (a2)

Re(548)>30 nm Expression (a1)′

1.5<Nz<10 Expression (a2)′

In the foregoing expressions, Nz=Rth(548)/Re(548)+0.5.

Also, the foregoing optical compensation film of the invention is preferably satisfied with the following expressions (a3) to (a6), more preferably satisfied with the following expressions (a3)′ and (a6)′ and further preferably satisfied with the following expressions (a3)″ to (a6)″. When the optical compensation film of the invention has the following optical characteristics, the tinting of the liquid crystal display device in an inclined direction can be further reduced, and therefore, such is preferable.

Re(446)/Re(548)≦1 Expression (a3)

1≦Re(628)/Re(548) Expression (a4)

Rth(446)/Rth(548)≦1 Expression (a5)

1≦Rth(628)/Rth(548) Expression (a6)

0.60≦Re(446)/Re(548)≦1.0 Expression (a3)′

1.0≦Re(628)/Re(548)≦1.25 Expression (a4)′

0.60≦Rth(446)/Rth(548)≦1.0 Expression (a5)′

1≦Rth(628)/Rth(548)≦1.25 Expression (a6)′

0.70≦Re(446)/Re(548)≦1.0 Expression (a3)″

1.0≦Re(628)/Re(548)≦1.15 Expression (a4)″

0.70≦Rth(446)/Rth(548)≦1.0 Expression (a5)″

1.0≦Rth(628)/Rth(548)≦1.15 Expression (a6)″

In particular, when the foregoing optical compensation film of the invention is satisfied with the following expressions (7a) to (9a), it is possible to much more reduce tinting in an inclined direction of the liquid crystal display device.

−2.5×Re(548)+300<Rth(548)<−2.5×Re(548)+500 Expression (7a)

−2.5×Re(446)+250<Rth(446)<−2.5×Re(446)+450 Expression (8a)

−2.5×Re(628)+350<Rth(628)<−2.5×Re(628)+550 Expression (9a)

### [Material Quality of Optical Compensation Film of the Invention]

As a material for forming the optical compensation film of the invention, polymers which are excellent in optical performance transparency, mechanical strength, heat stability, moisture shielding properties, isotropy and the like are preferable. Examples thereof include polycarbonate based polymers; polyester based polymers such as polyethylene terephthalate and polyethylene naphthalate; acrylic polymers such as polymethyl methacrylate; and styrene based polymers such as polystyrene and an acrylonitrile/styrene copolymer (AS copolymer). Other examples include polyolefins such as polyethylene and polypropylene; polyolefin based polymers such as an ethylene/propylene copolymer; vinyl chloride based polymers; amide based polymers such as nylons and aromatic polyamides; imide based polymers; sulfone based polymers; polyether sulfone based polymers; polyetheretherketone based polymers; polyphenylene sulfide based polymers; vinylidene chloride based polymers; polyvinyl alcohol based polymers; vinyl butyral based polymers; allylate based polymers; polyoxymethylene based polymers; epoxy based polymers; and mixed polymers of the foregoing polymers. The optical compensation film of the invention can also be formed as a cured layer of a UV-curable or thermo-curable resin such as acrylic, urethane based, acrylurethane based, epoxy based and silicone based resins.

As the material for forming the optical compensation film of the invention, a thermoplastic norbornene based resin can be preferably used. Examples of the thermoplastic norbornene based resin include ZEONEX Series and ZEONOR Series (manufactured by Zeon Corporation) and ARTON Series (manufactured by JSR Corporation).

Also, as the material for forming the optical compensation film of the invention, a cellulose based polymer (hereinafter referred to as “cellulose acylate”) which has hitherto been used as a transparent passivation film of a polarizing plate can be especially preferably used. Representative examples of the cellulose acylate include triacetyl cellulose.

Examples of the raw material cellulose of the cellulose acylate include cotton linter and wood pulps (for example, broad-leafed pulps and coniferous pulps), and cellulose acylates obtained from any of these raw material celluloses can be used. A mixture thereof may be used as the case may be. These raw material celluloses are described in detail in, for example, Courses of Plastic Materials (17): Cellulose Resins, written by Marusawa and Uda and published by The Nikkan Kogyo Shimbun, Ltd. (1970) and Journal of Technical Disclosure, No. 2001-1745 (pages 7 to 8). These materials can be used, but the invention is not particularly limited thereto with respect to the foregoing cellulose acylate film.

The optical compensation film of the invention can be used as a first optically anisotropic layer. It is preferable that the cellulose acylate film for the optically anisotropic layer is composed of a composition containing a cellulose acylate having two or more kinds of substituents. Preferred examples of such a cellulose acylate include mixed fatty acid esters having an acylation degree of from 2 to 2.9 and having an acyl group having from 3 to 4 carbon atoms with respect to the acetyl group thereof. The acylation degree of the foregoing mixed fatty acid ester is more preferably from 2.2 to 2.85, and further preferably from 2.4 to 2.8. An acetylation degree is preferably less than 2.5, and more preferably less than 1.9. In the fatty acid ester residue, it is preferable that the aliphatic acyl group has from 2 to 20 carbon atoms. Specific examples thereof include acetyl, propionyl, butyryl, isobutyryl, valeryl, pivaroyl, hexanoyl, octanoyl, lauroyl and stearoyl, with acetyl, propionyl and butyryl being preferable.

The foregoing cellulose acylate may be a mixed acid ester having a fatty acid acyl group and a substituted or unsubstituted aromatic acyl group.

In the case of a cellulose fatty acid monoester, a substitution degree of the aromatic acyl group is preferably not more than 2.0, and more preferably from 0.1 to 2.0 relative to the residual hydroxyl group. Also, in the case of a cellulose fatty acid diester (for example, cellulose diacetate), the substitution degree of the aromatic acyl group is preferably not more than 1.0, and more preferably from 0.1 to 1.0 relative to the residual hydroxyl group.

The foregoing cellulose acylate preferably has a mass average polymerization degree of from 350 to 800, and more preferably from 370 to 600. Also, the cellulose acylate which is used in the invention preferably has a number average molecular weight of from 70,000 to 230,000, more preferably from 75,000 to 230,000, and further preferably from 78,000 to 120,000.

The foregoing cellulose acylate can be synthesized by using, as an acylating agent, an acid anhydride or an acid chloride. In the most industrially general synthesis method, the cellulose ester is synthesized by esterifying a cellulose obtained from cotton linter, wood pulps or the like with a mixed organic acid component containing an organic acid corresponding to an acetyl group and other acyl group (for example, acetic acid, propionic acid and butyric acid) or an acid anhydride thereof (for example, acetic anhydride, propionic anhydride and butyric anhydride).

It is preferable that the foregoing cellulose acylate film is produced by the solvent casting method. With respect to the production method of a cellulose acylate film utilizing the solvent casting method, U.S. Pat. Nos. 2,336,310, 2,367,603, 2,492,078, 2,492,977, 2,492,978, 2,607,704, 2,739,069 and 2,739,070, U.K. Patents Nos. 640,731 and 736,892, JP-B-45-4554, JP-B-49-5614, JP-A-60-176834, JP-A-60-203430, JP-A-62-115035 and so on can be made hereof by reference. Also, the foregoing cellulose acylate film may be subjected to a stretching treatment. With respect to the method and condition of the stretching treatment, for example, JP-A-62-115035, JP-A-4-152125, JP-A-4-284211, JP-A-4-298310 and JP-A-11-48271 can be made hereof by reference.

### [Casting Method]

Examples of the casting method of a solution include a method in which a prepared dope is uniformly extruded onto a metal support from a pressure die; a method by a doctor blade in which the thickness of a dope having been once cast on a metal support is adjusted by a blade; and a method by a reverse roll coater in which the thickness of a dope having been once cast on a metal support is adjusted by a reversely rotating roll. Of these, a method by a pressure die is preferable. The pressure die includes a coat hunger type and a T-die type, and all of these types can be favorably used. Besides the methods as exemplified above, various conventionally known methods for casting and fabricating a cellulose triacetate solution can be employed. By setting up each condition while taking into consideration a difference in boiling point of a solvent to be used or the like, the same effects as the contents described in the respective patent documents are obtainable.

The optical compensation film of the invention is produced by a process including a step of forming a dope composition containing an organic solvent, a polymer and at least one kind of a compound represented by the foregoing formula (I) as a film core layer and a dope composition containing an organic solvent, a polymer and an inorganic particle as a film surface layer on a support and a step of stretching the obtained film.

### [Co-Casting]

In forming the optical compensation film of the invention, in order to make the inorganic particle in the film have the foregoing distribution, it is preferable to employ a stack casting method such as a co-casting method, a successive casting method and a coating method. Above all, it is especially preferable to employ a co-casting method.

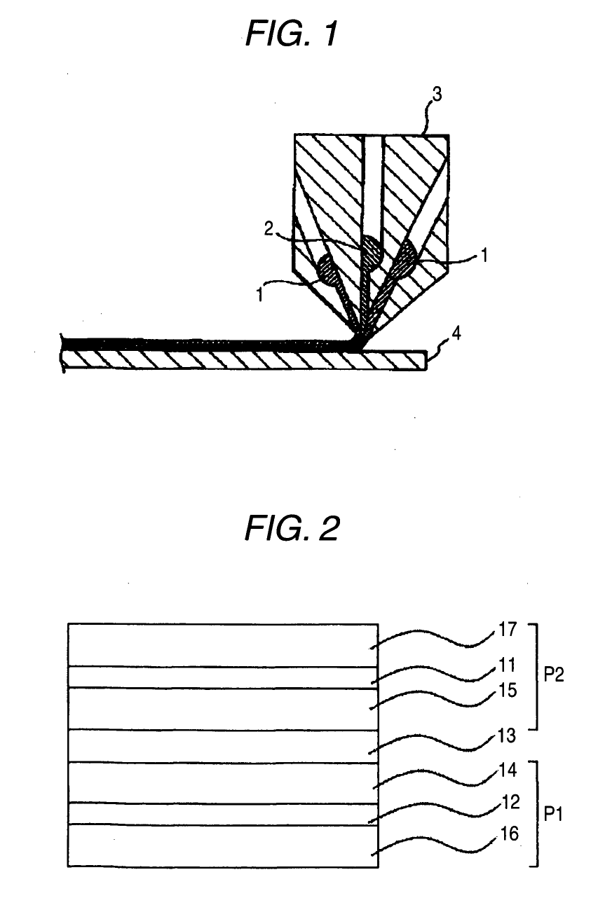

In the case of achieving the production by the co-casting method or the successive casting method, first of all, a cellulose acetate dope for each layer is prepared. The co-casting method (multilayer simultaneous casting) is a casting method in which casting dopes for respective layers (which may also be three or more layers) are each extruded on a casting support (for example, a band or a drum) from a casting Gieser for extruding from separate slits or the like; and the respective layers are simultaneously cast and stripped off from the support at an appropriate timing, followed by drying to form a film. FIG. 1 is a cross-sectional view showing a state that three layers of dopes 1 for surface layer and a dope 2 for core layer are simultaneously extruded on a casting support 4 by using a co-casting Gieser 3.

The successive casting method is a casting method in which a casting dope for first layer is first extruded and cast on a casting support from a casting Gieser; a casting dope for second layer is then extruded and cast thereon after drying or without being dried; if desired, a dope is further cast and stack in this manner with respect to third or more layers; and the layers are stripped off from the support at an appropriate timing, followed by drying to form a film. In general, the coating method is a method in which a film for core layer is formed into a film by the solution fabrication method; a coating solution for coating on a surface layer is prepared; and the coating solution is coated and dried on the film on every surface or both surfaces at the same time by using an appropriate coating machine to form a film of a stack structure.

As a metal support running in an endless manner, which is used for producing the cellulose acylate film to be favorably used in the invention, a drum in which a surface thereof is mirror-finished by chromium plating or a stainless steel belt (the belt may also be called a band) which is mirror-finished by surface polishing is useful. A pressure die to be used may be set up in the number of one or two or more in an upper part of the metal support. The number of the pressure die is preferably one or two. In the case where two or more pressure dies are set up, the amount of the dope to be cast may be divided in various proportions for the respective dies. Also, the dope may be sent to the dies in the respective proportions from plural precision metering gear pumps. The temperature of the cellulose acylate solution which is used for casting is preferably from −10 to 55° C., and more preferably from 25 to 50° C. In that case, the solution temperature may be identical in all of the steps, or the solution temperature may be different in each place of the steps. In the case where the solution temperature is different, it would be better that the solution temperature just before casting is a desired temperature.

### [Stretching Treatment]

In the process for producing a cellulose acylate film according to the invention, the cellulose acylate film is subjected to a stretching treatment. As described previously, the optical compensation film of the invention is characterized by having biaxial properties. According to the stretching treatment, it is possible to impart such optical performance, and furthermore, it is possible to impart desired retardation to the cellulose acylate film. With respect to the stretching direction of the cellulose acylate film, all of a width direction and a longitudinal direction are preferable, and a width direction is especially preferable.

A method for achieving stretching in a width direction is described in, for example, JP-A-62-115035, JP-A-4-152125, JP-A-4-284211, JP-A-4-298310 and JP-A-11-48271. In the case of stretching in a longitudinal direction, for example, the film is stretched by adjusting the speed of conveyance rollers of the film to make a winding-up speed of the film faster than a stripping-off speed of the film. In the case of stretching in a width direction, the film can also be stretched by conveying the film while holding the width of the film by a tenter and gradually widening the width of the tenter. After drying the film, the film can also be stretched by using a stretching machine (preferably uniaxially stretched by using a long stretching machine).

A stretch ratio of the cellulose acylate film of the invention is preferably 5% or more and not more than 200%, and more preferably 10% or more and not more than 100%.

In the case where the cellulose acylate film is used as a passivation film of a polarizer, for the purpose of inhibiting light leakage in viewing a polarizing plate from an inclined direction, it is necessary to dispose a transmission axis of the polarizer in parallel to an in-plane slow axis of the cellulose acylate film. Since the transmission axis of a polarizer in a rolled film state to be continuously produced is generally parallel to the width direction of the rolled film, in order to continuously stick a passivation film composed of the polarizer in a rolled film state and the cellulose acylate film in a rolled film state, it is necessary that the in-plane slow axis of the passivation film in a rolled film state is parallel to the width direction of the film. Accordingly, it is preferable that the film is more likely stretched in the width direction. Also, the stretching treatment may be achieved on the way of the fabrication step, and a raw film having been fabricated and wound up may be subjected to a stretching treatment. In the former case, the stretching may be carried out in a state of containing the residual solvent, and the film can be favorably stretched in a residual solvent amount of from 2 to 30% by mass.

### [Drying]

In general, examples of drying of the dope on the metal support according to the production of a cellulose acylate film include a method of blowing hot air from the surface side of the metal support (drum or belt), namely from the surface of a web on the metal support; a method of blowing hot air from the back surface of the drum or belt; and a back surface liquid heat conduction method by bringing a temperature-controlled liquid in contact with the back surface of the belt or drum, which is the side thereof opposite the dope casting surface, and heating the drum or belt due to heat conduction to control the surface temperature. Of these methods, the back surface liquid heat conduction method is preferable. The surface temperature of the metal support before casting may be arbitrary so far as it is not higher than a boiling point of the solvent to be used in the dope. However, in order to accelerate drying or eliminate fluidity on the metal support, it is preferable that the surface temperature of the metal support is set up at a temperature of from 1 to 10° C. lower than a boiling point of the solvent having the lowest boiling point among the solvents to be used. However, this limitation is not necessarily applied in the case where the casting dope is cooled and stripped off without being dried.

The thickness of the cellulose acylate film obtained after drying, which is favorably used in the invention, varies with the purpose for use. Usually, it is preferably in the range of from 5 to 500 μm, more preferably from 20 to 300 μm, and especially preferably from 30 to 150 μm. Also, the thickness of the cellulose acylate film for optical use, especially for a VA mode liquid crystal display device is preferably from 40 to 110 μm.

Also, a ratio of the surface layer to the whole of the film layers is preferably in the range of from 1 to 50%, more preferably in the range of from 1 to 30%, and especially preferably in the range of from 1 to 20%. Though the film surface layer may be provided only on one side, it is preferable that the film surface layer is provided on the both sides of the film.

In order to adjust the thickness of the film to a desired value, the concentration of solids to be contained in the dope, the gap of a slit of a nozzle of the die, the extrusion pressure of the die, the speed of the metal support, etc. may be properly adjusted.

The width of the thus obtained cellulose acylate film is preferably from 0.5 to 3 m, more preferably from 0.6 to 2.5 m, and further preferably from 0.8 to 2.2 m. The cellulose acylate film is preferably wound up in a length of from 100 to 10,000 m, more preferably from 500 to 7,000 m, and further preferably from 1,000 to 6,000 m per roll. In winding up, the film is preferably knurled at least in one edge thereof. The width of the knurl is preferably from 3 mm to 50 mm, and more preferably from 5 mm to 30 mm; and the height of the knurl is preferably from 0.5 to 500 μm, and more preferably from 1 to 200 μm. The edge of the film may be knurled on one or both surfaces thereof.

### [Plasticizer]

A plasticizer such as triphenyl phosphate and biphenyl phosphate may be added in the cellulose acylate film which is used as the foregoing first and second optically anisotropic layers.

In general, in a large-sized screen display device, since lowering in contrast and tinting in an inclined direction become remarkable, the optical compensation film of the invention is especially suitable for the use in a large-sized screen display device. In the case of using the optical compensation film of the invention as an optical compensation film for large-sized screen display device, for example, it is preferable that a film is formed in a width of 1,470 mm or more. Also, the optical compensation film of the invention includes not only a film of an embodiment of a film piece cut into a size such that it is able to be installed as it stands in a liquid crystal display device but a film of an embodiment in which the film is prepared in a longitudinal form by means of continuous production and wound up in a rolled state. In the optical compensation film of the latter embodiment, after storage and conveyance in that state or the like, the film is cut into a desired size and used at the time of actually installing in a liquid crystal display device or sticking to a polarizer or the like. Also, after sticking the film in a longitudinal form to a polarizer composed of a polyvinyl alcohol film or the like as prepared similarly in a longitudinal form, when the resulting film is actually installed in a liquid crystal display device, it is cut into a desired size and used. As one of the embodiments of an optical compensation film wound up in a rolled state, an embodiment in which the film is wound up in a rolled state having a roll length of 2,500 m or more is exemplified.

### [Liquid Crystal Display Device of the Invention]

The invention is also concerned with a liquid crystal display device having the optical compensation film of the invention and a polarizing plate.

The liquid crystal display device of the invention has a pair of first and second polarizers; a liquid crystal cell disposed between the pair of polarizers; and the optical compensation film of the invention between the first polarizer and the liquid crystal cell.

It is preferable that the liquid crystal display device of the invention has a polarizing plate as described later, a liquid crystal cell and an optically anisotropic layer which is satisfied with the following expressions (b1) and (b2) (hereinafter often referred to as “second optically anisotropic layer”).

|Rth(548)/Re(548)|>10 Expression (b1)

Rth(628)−Rth(446)<0 Expression (b2)

Though the mode of the liquid crystal display device of the invention is not particularly limited, a horizontal alignment mode such as an IPS mode and a vertical alignment mode, in which twisted alignment is not utilized for the liquid crystal cell, are preferable, with a vertical alignment mode being more preferable.

FIG. 2 shows one example of a cross-sectional diagrammatic schematic view of the liquid crystal display device of the foregoing embodiment.

The liquid crystal display device of FIG. 2 is a configuration example of a liquid crystal display device of a VA mode and has a liquid crystal cell 13 of a VA mode and a pair of polarizing plates P1 and P2 disposed while interposing the liquid crystal cell 13 therebetween. The polarizing plate P1 has a polarizing film 12 and passivation films 14 and 16 disposed on both surfaces thereof. The passivation film 14 disposed on a side of the liquid crystal cell 13 is an optical compensation film which is satisfied with the foregoing expressions (a1) to (a6) and functions as a first optically anisotropic layer (accordingly, this will be hereinafter often referred to as “first optically anisotropic layer”).

The polarizing plate P2 has a polarizing film 11 and passivation films 15 and 17 disposed on both surfaces thereof. The passivation film 15 disposed on a side of the liquid crystal cell 13 is an optical film which is satisfied with the foregoing expressions (b1) and (b2) and functions as a second optically anisotropic layer (accordingly, this will be hereinafter often referred to as “second optically anisotropic layer”).

The polarizing films 11 and 12 are usually disposed such that transmission axes of the both are orthogonal each other. Also, the first optically anisotropic layer 14 has an in-plane slow axis, and it is preferable that the slow axis is disposed orthogonal to the absorption axis of the first polarizing film 12.

In the VA mode liquid crystal display device of the embodiment as illustrated in FIG. 2, by using P1 which is the polarizing plate of the invention, ideal neutral black is achieved in a front direction at the time of black displaying. Also, by using the first optically anisotropic layer 14 which is satisfied with the foregoing expressions (a1) to (a6) and the second optically anisotropic layer which is satisfied with the foregoing expressions (b1) and (b2), even in an inclined direction, the change in hue from ideal black in a front direction is prevented, and tinting and lowering in contrast are reduced.

One example of the liquid crystal display device of the invention is described by using a Poincare sphere.

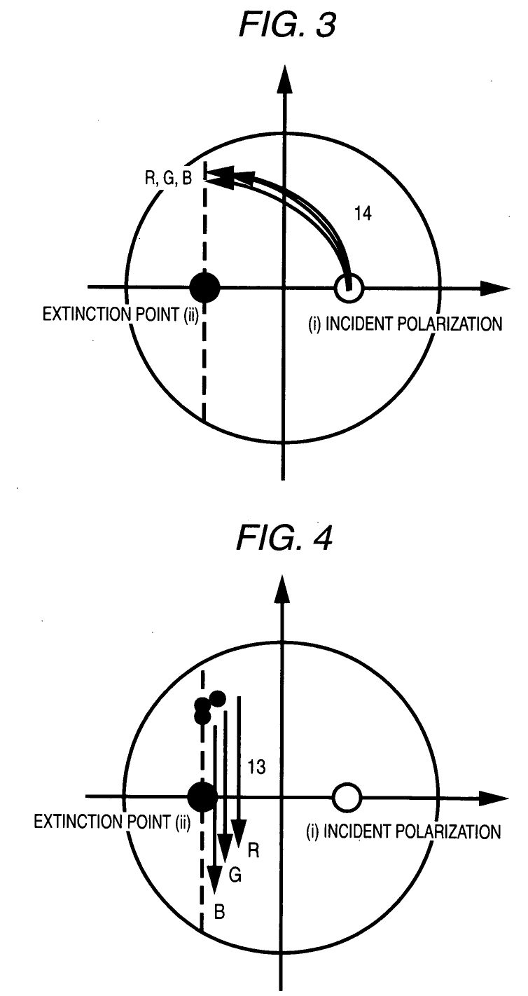

FIGS. 3 to 5 are each a view in which the change in a polarization state of incident light in the liquid crystal display device as illustrated in FIG. 2 is shown on a Poincare sphere. The Poincare sphere is a three-dimensional map expressing the polarization state, and the equator of the sphere represents linear polarization. Here, the propagation direction of light in the liquid crystal display device is located at an azimuth angle of 45 degrees and a polar angle of 34 degrees. In FIGS. 3 to 5, the S2 axis is an axis penetrating vertically from the bottom to the top on the paper; and FIGS. 3 to 5 are each a view in which the Poincare sphere is viewed from a positive direction of the S2 axis. Here, the coordinates of S1, S2 and S3 express a Stokes parameter value in a certain polarization state. Also, since FIGS. 3 to 5 are each shown planar, displacement of a point before and after change of the polarization state is shown by a linear arrow in the drawing. However, actually, the change in the polarization state to be caused due to passing through the liquid crystal layer or the optical compensation film is expressed on the Poincare sphere by rotating at a specified angle around a specified axis to be determined depending upon the respective optical characteristics. Its rotation angle is in proportion to a reciprocal of the wavelength of incident light and in proportion to a size of retardation in a retardation region through which the incident light passes.

The polarization state of incident light which has passed through the polarizing film 12 of the liquid crystal display device as illustrated in FIG. 2 is corresponding to a point (i) in FIGS. 3 to 5; and the polarization state of incident light which has been shaded by the absorption axis of the polarizing film 11 in FIG. 2 is corresponding to a point (ii) in FIG. 3. Conventionally, in a VA mode liquid crystal display device, passing-through of light of OFF AXIS in an inclined direction is caused due to a deviation of the polarization state of outgoing light from the point (ii). The first optically anisotropic layer 14 and the second optically anisotropic layer 15 are used for changing the polarization state of incident light correctly from the point (i) to the point (ii) inclusive of the change in the polarization state in the liquid crystal cell 13.

First of all, the polarization state of light which has passed through the first optically anisotropic layer 14 is converted due to a retardation of the first optically anisotropic layer 14. On that occasion, the size of the conversion, namely the rotation angle on the Poincare sphere becomes small depending upon the wavelength. On the other hand, the retardation of the first optically anisotropic layer 14 exhibits reverse dispersibility, and respective factors offset each other, whereby as illustrated in FIG. 3, with respect to all of R light, G light and B light, the polarization state of light which has passed through the first optically anisotropic layer 14 is substantially coincident in terms of the S1 coordinates on the Poincare sphere.

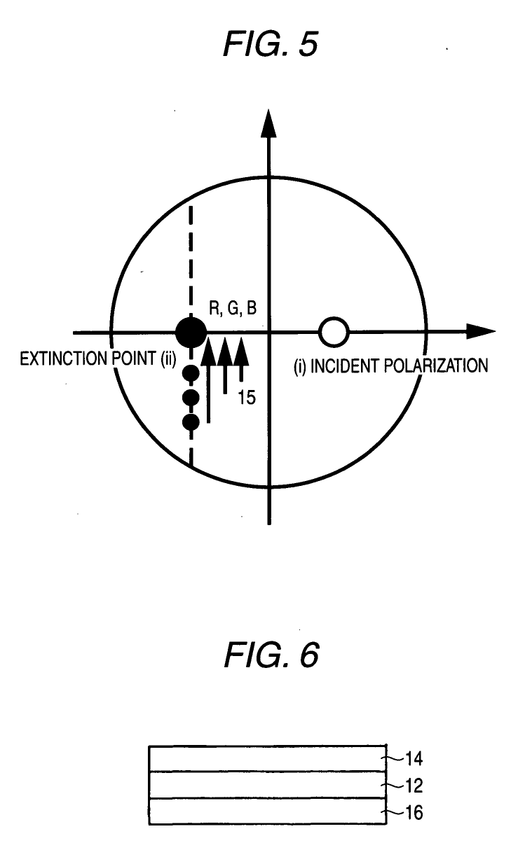

Thereafter, as illustrated in FIG. 4, when the light has passed through the liquid crystal cell 13 of a VA mode, the polarization state of R light, G light and B light changes as shown by an arrow 13 in the drawing, and the S3 coordinates differ from each other and are separated. However, this separation can be overcome by utilizing the wavelength dispersibility of the second optically anisotropic layer 15. More concretely, when a material which is satisfied with the foregoing expression (b2) and in which the wavelength dispersibility of Rth exhibits normal dispersibility is used in the second optically anisotropic layer 15, as shown by an arrow 15 in FIG. 5, the S1 coordinates of R light, G light and B light can be converted on the S1 axis, namely in a polarization state of the extinction point (ii). As a result, not only tinting can be more reduced, but the contrast can be more improved in an inclined direction.

The optical compensation mechanisms as illustrated in FIGS. 3 to 5 are merely an example, and it should not be construed that the invention is limited thereto.

Also, it should not be construed that the liquid crystal display device of the invention is limited to the configuration as illustrated in FIG. 2. In FIG. 2, the second optically anisotropic layer and the first optically anisotropic layer are disposed while interposing the liquid crystal cell therebetween. However, an embodiment in which the second optically anisotropic layer is stacked on the first optically anisotropic layer may be employed.

### [Preparation of Second Optically Anisotropic Layer]

A material of the foregoing second optically anisotropic layer is not particularly limited. In particular, the material can be selected and used among the same materials as in the foregoing optical compensation film of the invention.

In particular, a cellulose acylate polymer can be favorably used as the material for forming the second optically anisotropic layer.

It is preferable that the cellulose acylate film for the second optically anisotropic layer is composed of a composition containing a cellulose acylate having two or more kinds of substituents. Preferred examples of such a cellulose acylate include a mixed fatty acid ester having an acylation degree of from 2 to 2.9 and having an acyl group having from 3 to 4 carbon atoms with respect to the acetyl group thereof. The acylation degree of the foregoing mixed fatty acid ester is more preferably from 2.2 to 2.85, and further preferably from 2.4 to 2.8. An acetylation degree is preferably less than 2.5, and more preferably less than 1.9. In the fatty acid ester residue, it is preferable that the aliphatic acyl group has from 2 to 20 carbon atoms. Specific examples thereof include acetyl, propionyl, butyryl, isobutyryl, valeryl, pivaroyl, hexanoyl, octanoyl, lauroyl and stearoyl, with acetyl, propionyl and butyryl being preferable.

The foregoing cellulose acylate may be a mixed acid ester having a fatty acid acyl group and a substituted or unsubstituted aromatic acyl group.

In the case of a cellulose fatty acid monoester, a substitution degree of the aromatic acyl group is preferably not more than 2.0, and more preferably from 0.1 to 2.0 relative to the residual hydroxyl group. Also, in the case of a cellulose fatty acid diester (for example, cellulose diacetate), the substitution degree of the aromatic acyl group is preferably not more than 1.0, and more preferably from 0.1 to 1.0 relative to the residual hydroxyl group.

The foregoing cellulose acylate preferably has a mass average polymerization degree of from 350 to 800, and more preferably from 370 to 600. Also, the cellulose acylate which is used in the invention preferably has a number average molecular weight of from 70,000 to 230,000, more preferably from 75,000 to 230,000, and further preferably from 78,000 to 120,000.

The foregoing cellulose acylate can be synthesized by using, as an acylating agent, an acid anhydride or an acid chloride. In the most industrially general synthesis method, the cellulose ester is synthesized by esterifying a cellulose obtained from cotton linter, wood pulps or the like with a mixed organic acid component containing an organic acid corresponding to an acetyl group and other acyl group (for example, acetic acid, propionic acid and butyric acid) or an acid anhydride thereof (for example, acetic anhydride, propionic anhydride and butyric anhydride).

It is preferable that the foregoing cellulose acylate film is produced by the solvent casting method. With respect to the production method of a cellulose acylate film utilizing the solvent casting method, U.S. Pat. Nos. 2,336,310, 2,367,603, 2,492,078, 2,492,977, 2,492,978, 2,607,704, 2,739,069 and 2,739,070, U.K. Patents Nos. 640,731 and 736,892, JP-B-45-4554, JP-B-49-5614, JP-A-60-176834, JP-A-60-203430, JP-A-62-115035 and so on can be made hereof by reference. Also, the foregoing cellulose acylate film may be subjected to a stretching treatment as the need arises. With respect to the method and condition of the stretching treatment, for example, JP-A-62-115035, JP-A-4-152125, JP-A-4-284211, JP-A-4-298310 and JP-A-11-48271 can be made hereof by reference.

### [Rth Developing Agent]

In the cellulose acylate film of the invention, it is preferable that an Rth developing agent is added in the cellulose acylate film. The “Rth developing agent” as referred to herein is a compound having properties for developing birefringence in a thickness direction of the film.

The foregoing Rth developing agent is preferably a compound with large polarizability anisotropy having absorption maximum in a wavelength range of from 250 nm to 380 nm is preferably as, and more preferably a compound represented by the following formula (III).

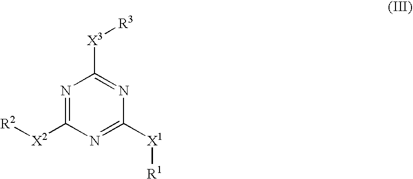

In the formula (III), X¹ represents a single bond, —NR⁴—, —O— or —S—; X² represents a single bond, —NR⁵—, —O— or —S—; and X³ represents a single bond, —NR⁶—, —O— or —S—. Also, R¹, R² and R³ each independently represents an alkyl group, an alkenyl group, an aromatic cyclic group or a heterocyclic group; and R⁴, R⁵ and R⁶ each independently represents a hydrogen atom, an alkyl group, an alkenyl group, an aryl group or a heterocyclic group.

Preferred examples of the compound represented by the foregoing formula (III) include the following I-(1) to IV-(10). However, it should not be construed that the invention is limited to these specific examples.

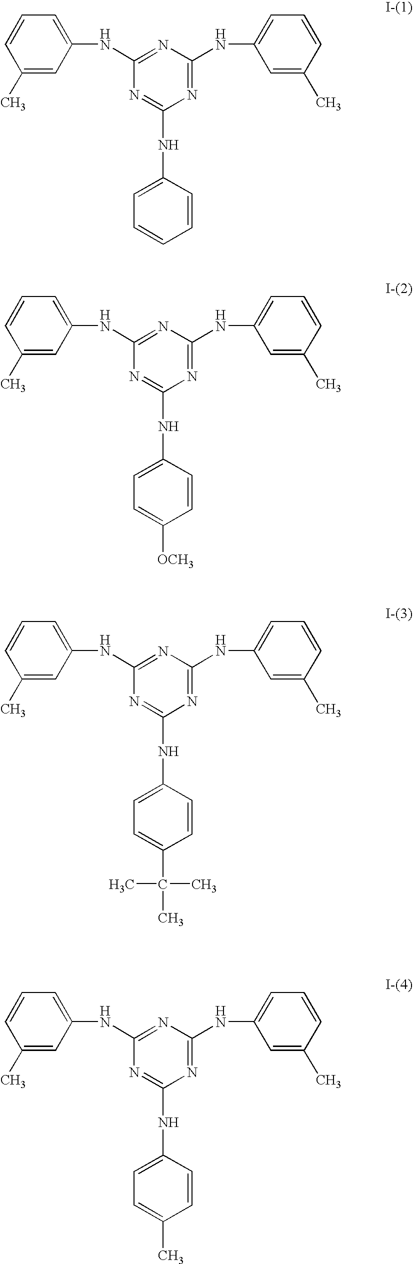

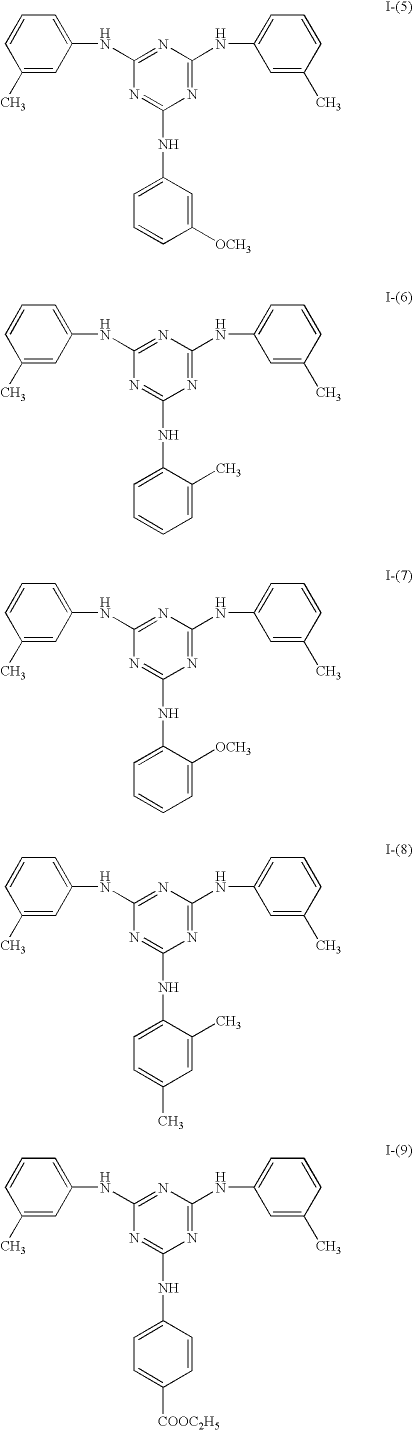

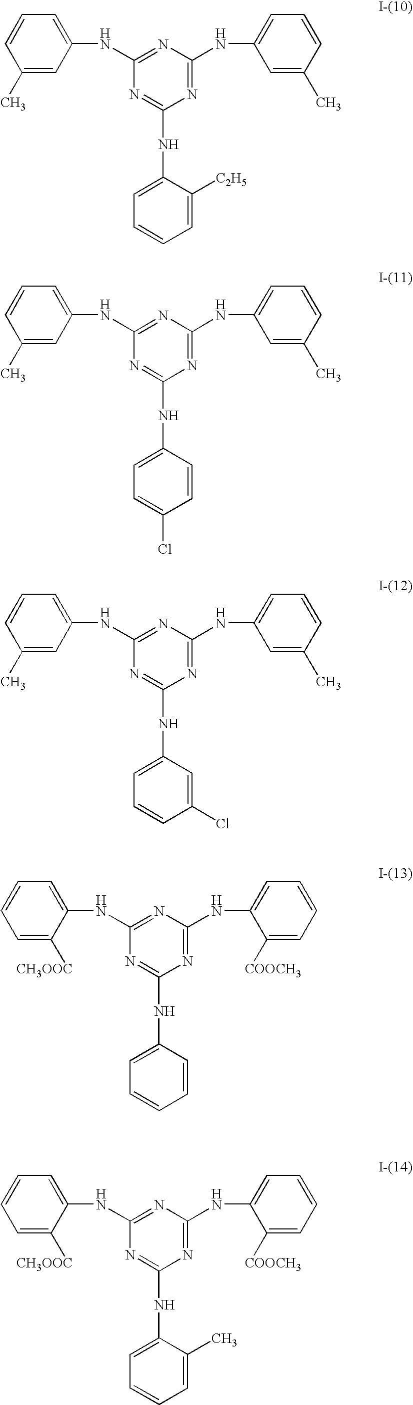

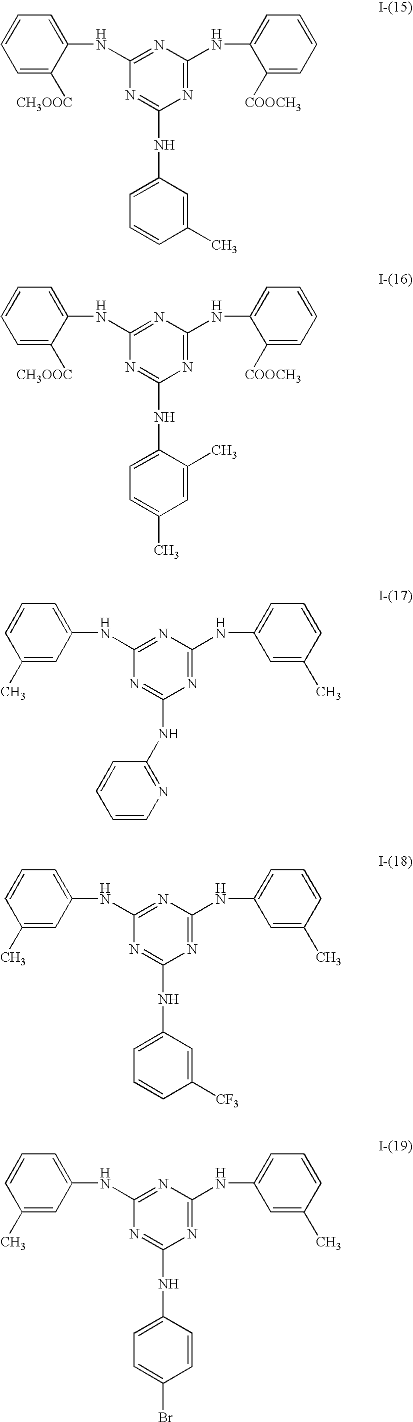

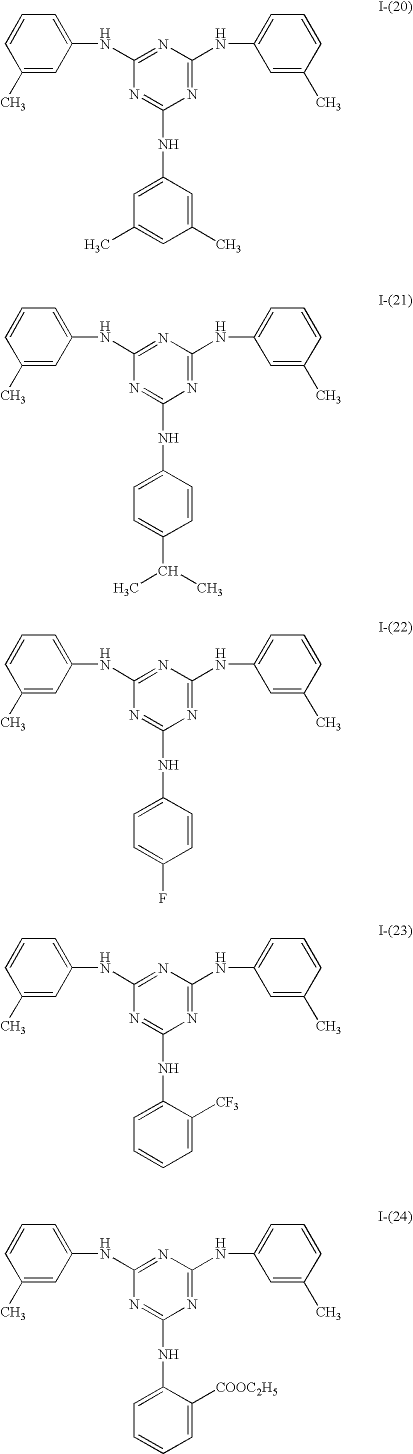

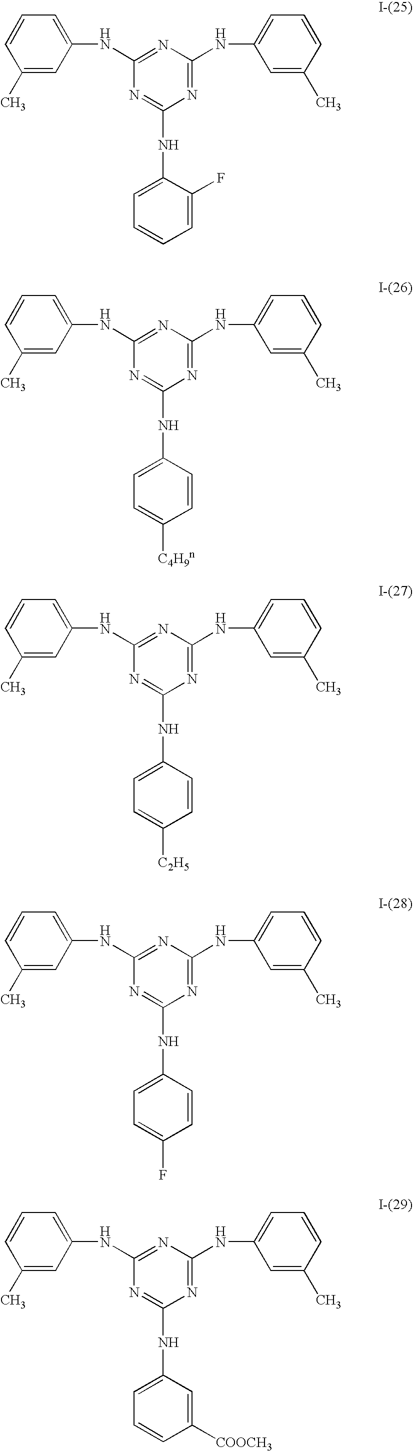

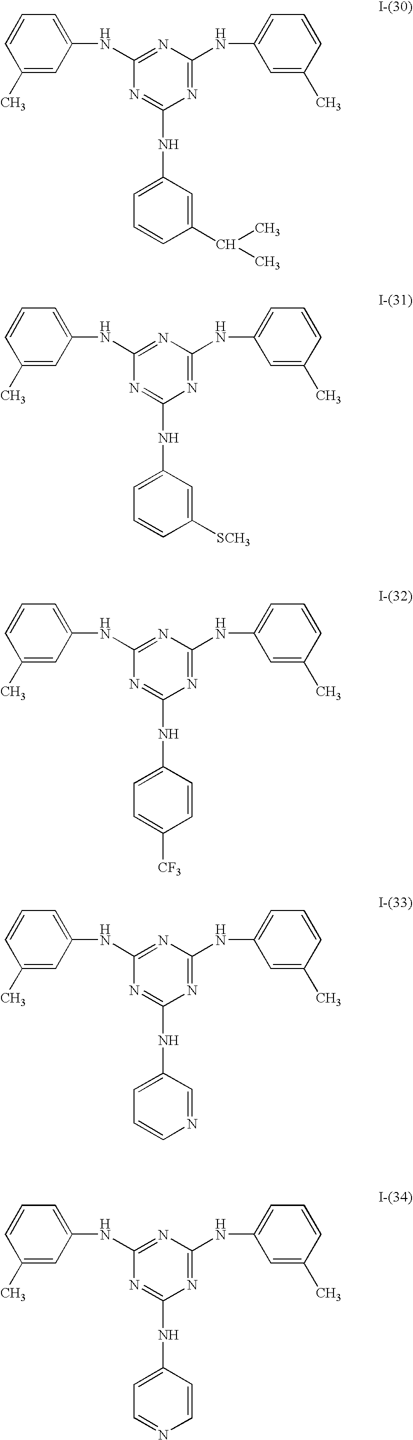

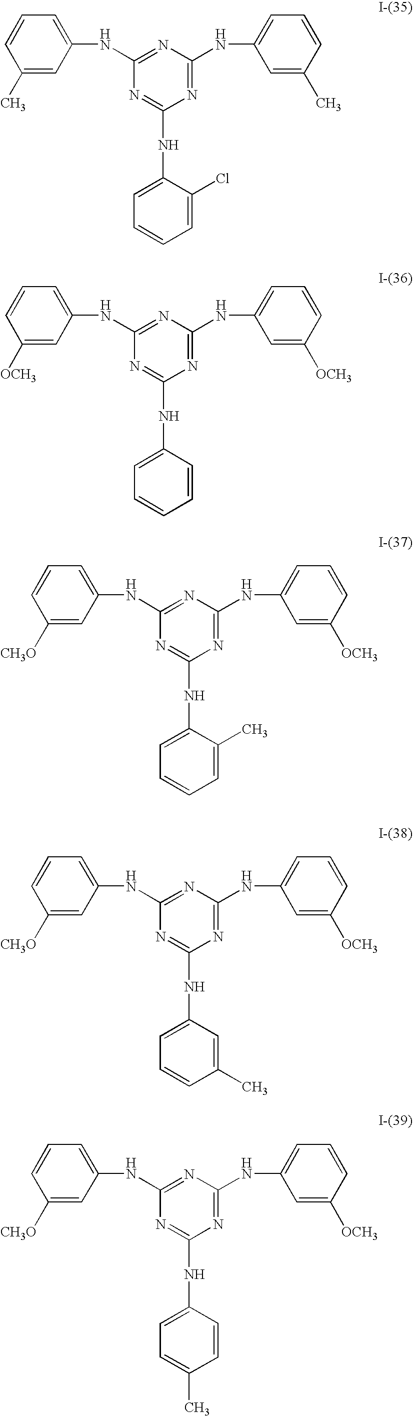

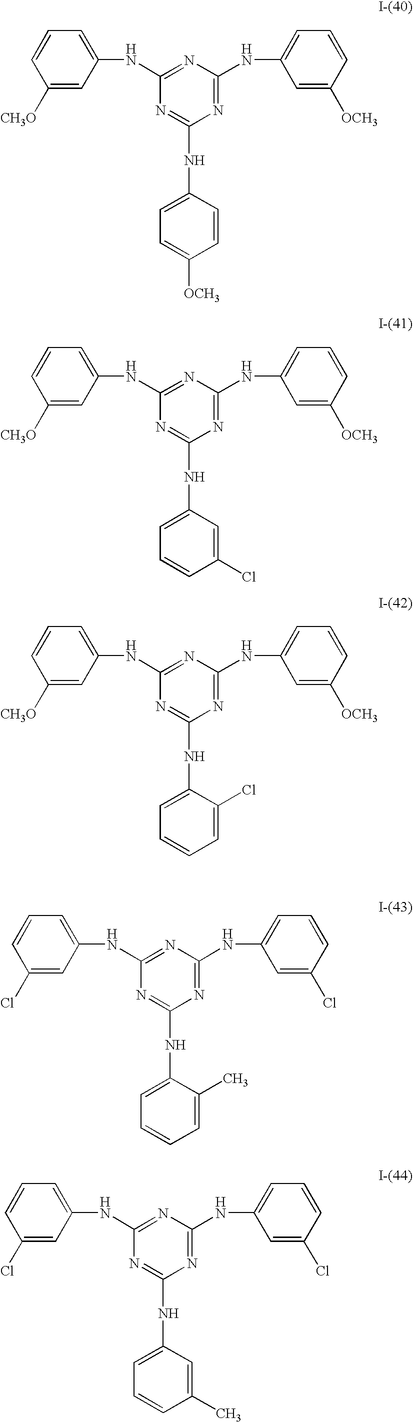

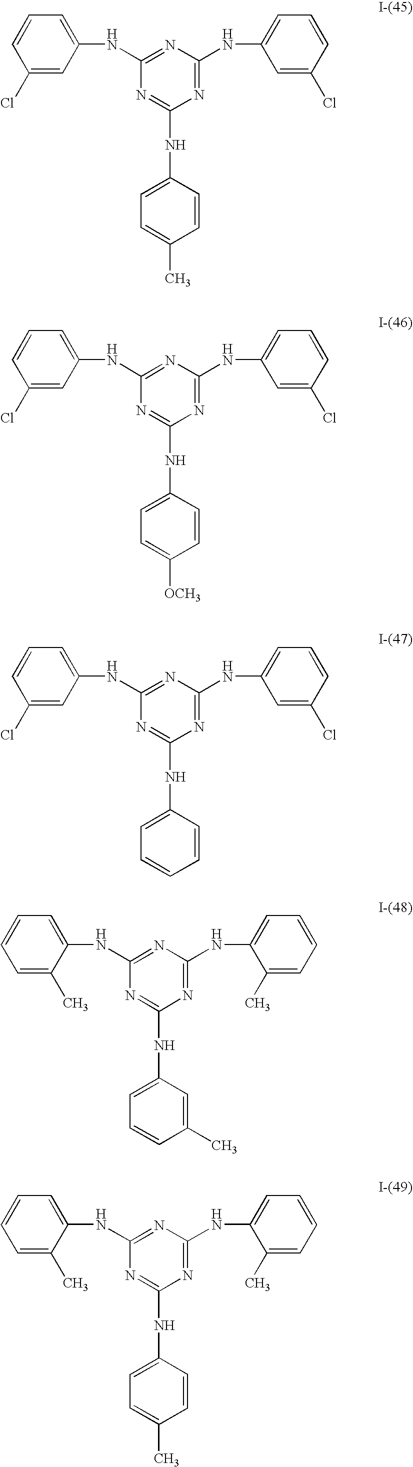

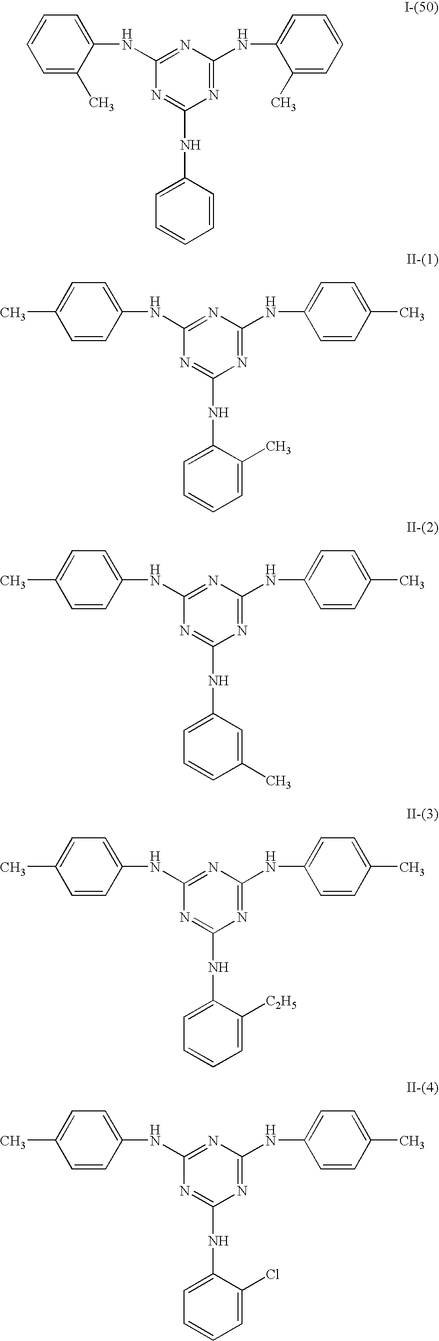

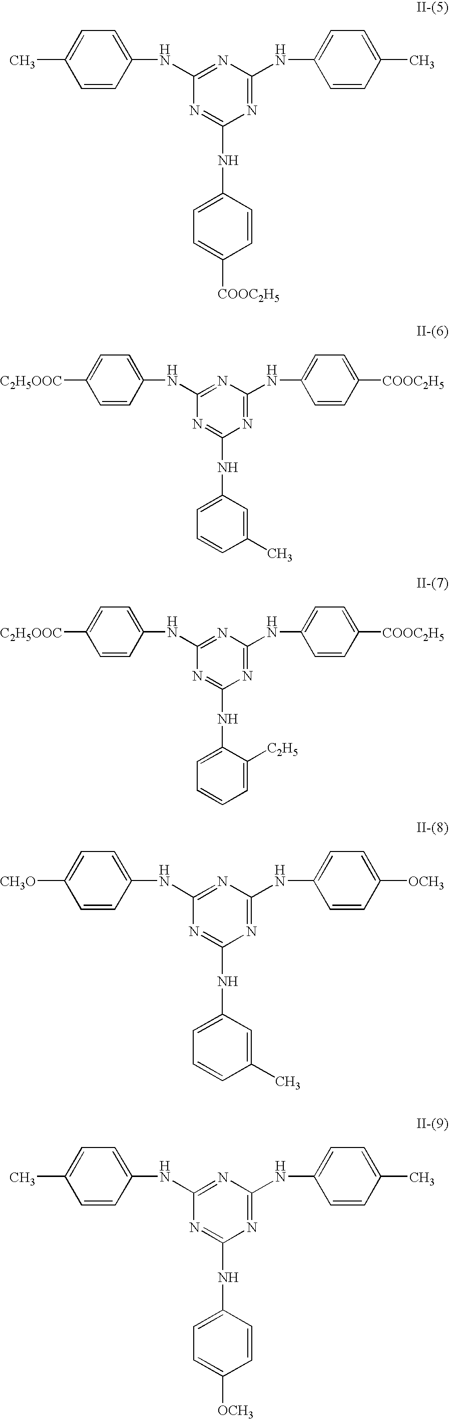

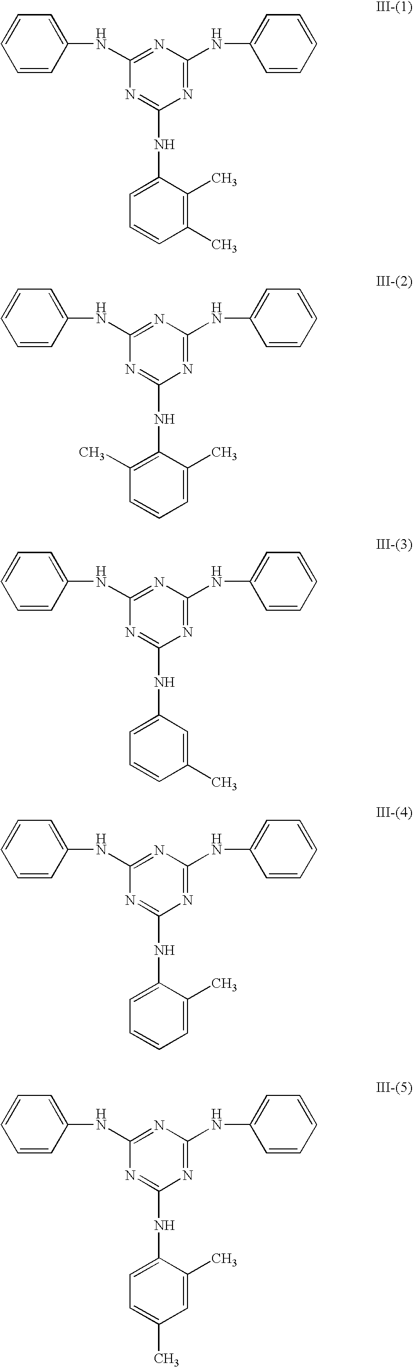

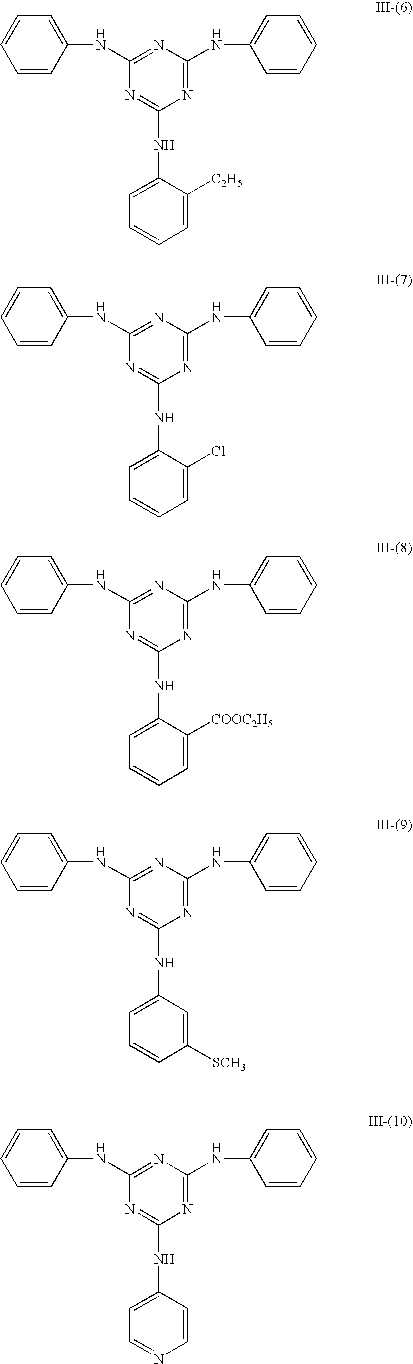

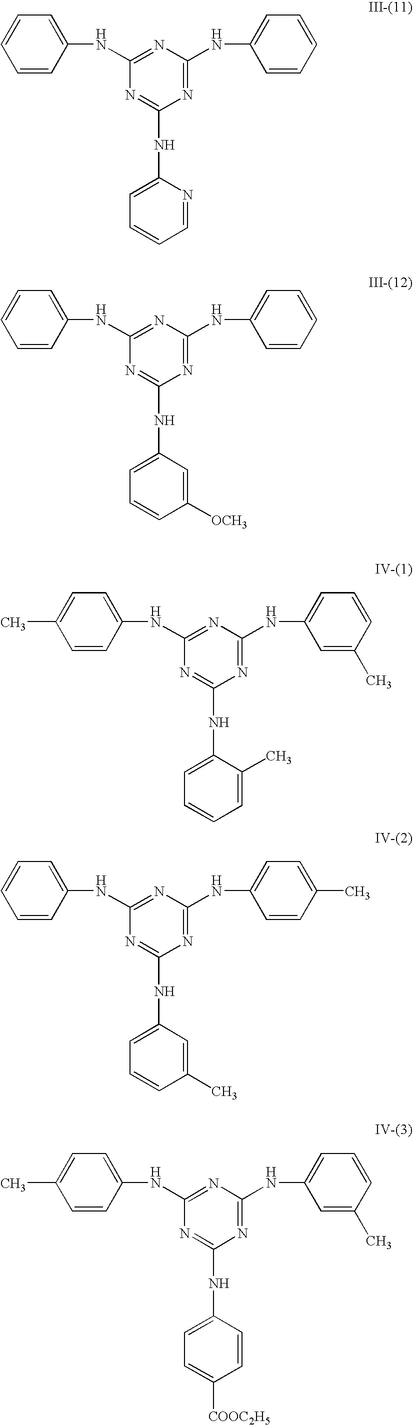

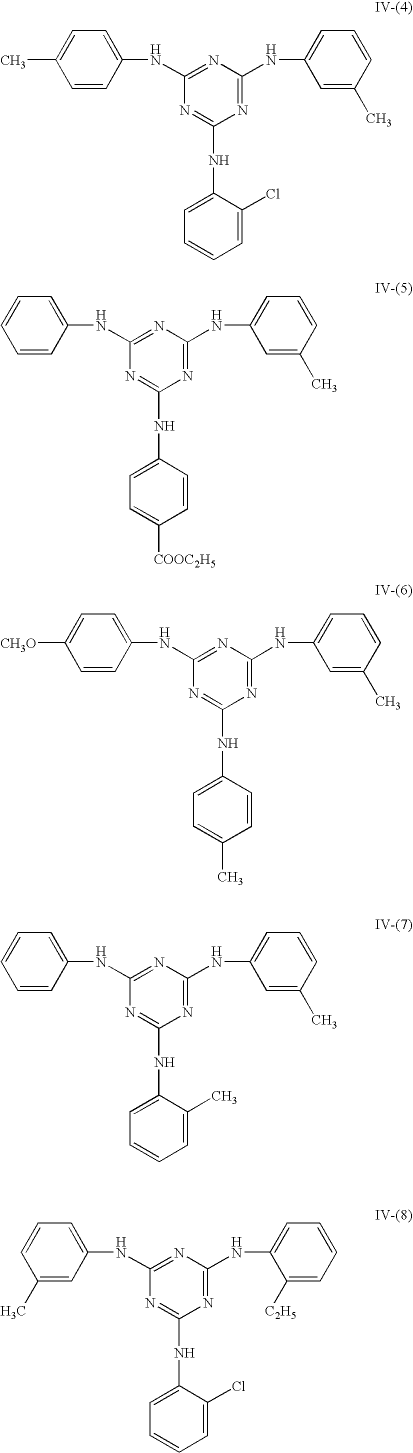

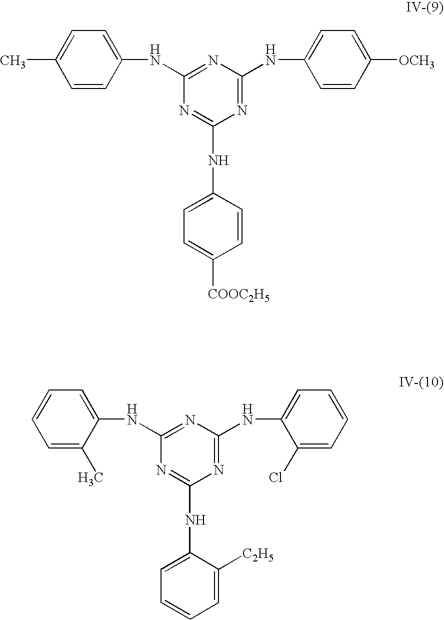

### [Polarizing Plate]

Also, the invention is concerned with a polarizing plate having a polarizer and the optical compensation film of the invention on one surface of the polarizer. Similar to the optical compensation film of the invention, an embodiment of the polarizing plate of the invention includes not only a polarizing plate of an embodiment of a film piece cut into a size such that it is able to be installed as it stands in a liquid crystal display device but a polarizing plate of an embodiment in which the plate is prepared in a longitudinal form by means of continuous production and wound up in a rolled state (for example, an embodiment having a roll length of 2,500 mm or more or 3,900 m or more). In order to make it suitable for a large-sized screen liquid crystal display device, the polarizing plate is prepared so as to have a width of 1,470 mm or more.

FIG. 6 shows a cross-sectional diagrammatic schematic view of an embodiment of the polarizing plate of the invention. The polarizing plate as illustrated in FIG. 6 has a polarizer 12 composed of a polyvinyl alcohol film dyed with iodine or a dichroic dye or the like and an optical compensation film 14 of the invention as disposed as a passivation film on one surface thereof and a passivation film 16 on the other surface thereof, respectively. In installing this polarizing film in a liquid crystal display device, it is preferable that the optical compensation film 14 is disposed on the liquid crystal side.

Since the passivation film 16 is disposed more outside, it is preferable in view of durability to use a material with low moisture permeability. Concretely, it is preferable to use a film having a water vapor permeability of not more than 300 g/(m²·day); and it is more preferable to use a film having a water vapor permeability of not more than 100 g/(m²·day). A lower limit of the water vapor permeability is not particularly limited, but in general, a lower limit of the water vapor permeability of the film is about 10 g/(m²·day). As the passivation film exhibiting such characteristics, a norbornene based polymer film is preferable. ZEONOR films as a commercially available product and the like can be used. The water vapor permeability of the film as referred to herein means a value as measured at 40° C. and 60% RH. The details are described in JIS0208.

For a reason that a film with low water vapor permeability is low in adhesiveness to the polarizer and other reasons, a passivation film of the polarizer 12 may be separately disposed between the polarizer 12 and the film 16 with low moisture permeability. A cellulose acylate film is preferable as this passivation film.

Though a passivation film having a function to separately passivate the polarizer may be disposed between the polarizer 12 and the optical compensation film 14, in order that such a passivation film may not lower the optical compensation ability, it is preferable to use a film having a retardation of substantially zero, for example, a cellulose acylate film described in JP-A-2005-138375,

### EXAMPLES

The invention is specifically described below with reference to the following Examples. Materials, reagents, substance amounts and proportions thereof, operations and so on can be properly varied so far as they do not deviate from the gist of the invention. Accordingly, it should not be construed that the scope of the invention is limited to the following specific examples.

### Comparative Example 1

### Preparation of Cellulose Acylate Film Sample 100

### (Preparation of Cellulose Acetate Solution 100)

The following composition was thrown into a mixing tank and stirred to dissolve the respective components, thereby preparing a cellulose acetate solution.

| | | |
|---|---|---|
| Cellulose acetate (substitution degree: 2.79): | 100.0 | parts by mass |
| Triphenyl phosphate: | 6.3 | parts by mass |
| Biphenyl phosphate: | 5.0 | parts by mass |
| Methylene chloride: | 366.5 | parts by mass |
| Methanol: | 54.8 | parts by mass |

### (Preparation of Additive Solution 100)

The following composition was thrown into a mixing tank and stirred to dissolve the respective components, thereby preparing an additive solution.

| | | |
|---|---|---|
| Illustrative Compound (I-(2)): | 10.0 | parts by mass |
| Methylene chloride: | 36.8 | parts by mass |
| Methanol: | 5.5 | parts by mass |
| Cellulose acetate solution 100: | 12.8 | parts by mass |

### (Preparation of Matting Agent Dispersion 100)

The following composition was thrown into a dispersing machine and stirred to dissolve the respective components, thereby preparing a matting agent solution.

| | | |
|---|---|---|
| Silica particle having an average | 2.0 | parts by mass |
| particle size of 20 nm (AEROSIL R972, | | |
| manufactured by Nippon Aerosil Co., Ltd.): | | |
| Methylene chloride: | 76.3 | parts by mass |
| Methanol: | 11.4 | parts by mass |
| Cellulose acetate solution 100: | 10.3 | parts by mass |

### (Fabrication)

The foregoing cellulose acetate solution, additive solution and matting agent dispersion were mixed in the following proportion to prepare a dope for fabrication.

### (Preparation of Dope 100 for Fabrication)

The following composition was thrown into a mixing tank and stirred, and the respective components were adjusted so as to have a ratio as described later and mixed for dissolution, thereby preparing a dope for fabrication.

| | | |
|---|---|---|
| Cellulose acetate solution 100: | 90.3 | parts by mass |
| Additive solution 100: | 8.4 | parts by mass |
| Matting agent dispersion 100: | 1.3 | parts by mass |

### (Casting)

The foregoing dope for fabrication was cast by using a band casting machine. The obtained web was stripped off from the band and laterally stretched in a stretch ratio of 25% under a condition at 130° C. by using a tenter; and after removing a clip, the resulting web was dried at 130° C. for 20 minutes to prepare a stretched cellulose acylate film sample 100 having a thickness after stretching of 80 μm. Each composition is shown in Table 1.

### Comparative Example 2

### Preparation of Cellulose Acylate Film Sample 101

### (Preparation of Cellulose Acetate Solution 101)

The following composition was thrown into a mixing tank and stirred to dissolve the respective components, thereby preparing a cellulose acetate solution.

| | | |
|---|---|---|
| Cellulose acetate (substitution degree: 2.8): | 100.0 | parts by mass |
| Triphenyl phosphate: | 6.3 | parts by mass |
| Biphenyl phosphate: | 5.0 | parts by mass |
| Illustrative Compound (I-2): | 2.0 | parts by mass |
| Methylene chloride: | 366.5 | parts by mass |
| Methanol: | 54.8 | parts by mass |

### (Preparation of Additive Solution 101)

The following composition was thrown into a mixing tank and stirred to dissolve the respective components, thereby preparing an additive solution.

| | | |
|---|---|---|
| Illustrative Compound (112): | 10.0 | parts by mass |
| Methylene chloride: | 36.8 | parts by mass |
| Methanol: | 5.5 | parts by mass |
| Cellulose acetate solution 101: | 12.8 | parts by mass |

### (Preparation of Matting Agent Dispersion 101)

The following composition was thrown into a dispersing machine and stirred to dissolve the respective components, thereby preparing a matting agent solution.

| | | |
|---|---|---|
| Silica particle having an average | 2.0 | parts by mass |
| particle size of 20 nm (AEROSIL R972, | | |
| manufactured by Nippon Aerosil Co., Ltd.): | | |
| Methylene chloride: | 76.3 | parts by mass |
| Methanol: | 11.4 | parts by mass |
| Cellulose acetate solution 101: | 10.3 | parts by mass |

### (Fabrication)

The foregoing cellulose acetate solution, additive solution and matting agent dispersion were mixed in the following proportion to prepare a dope for fabrication.

### (Preparation of Dope 101 for Fabrication)

The following composition was thrown into a mixing tank and stirred, and the respective components were adjusted so as to have a ratio as described later and mixed for dissolution, thereby preparing a dope for fabrication.

| | | |
|---|---|---|
| Cellulose acetate solution 101: | 90.8 | parts by mass |
| Additive solution 101: | 7.9 | parts by mass |
| Matting agent dispersion 101: | 1.3 | parts by mass |

### (Casting)

The foregoing dope for fabrication was cast by using a band casting machine. The obtained web was stripped off from the band and laterally stretched in a stretch ratio of 20% under a condition at 130° C. by using a tenter; and after removing a clip, the resulting web was dried at 130° C. for 20 minutes to prepare a stretched cellulose acylate film sample 101 having a thickness after stretching of 80 μm. Each composition is shown in Table 1.

### Example 1

### Preparation of Cellulose Acylate Film Sample 102

### (Preparation of Cellulose Acetate Solution 102)

The following composition was thrown into a mixing tank and stirred to dissolve the respective components, thereby preparing a cellulose acetate solution.

| | | |
|---|---|---|
| Cellulose acetate (substitution degree: 2.86): | 100.0 | parts by mass |
| Triphenyl phosphate: | 6.3 | parts by mass |
| Biphenyl phosphate: | 5.0 | parts by mass |
| Methylene chloride: | 366.5 | parts by mass |
| Methanol: | 54.8 | parts by mass |

### (Preparation of Matting Agent Dispersion 102)

The following composition was thrown into a dispersing machine and stirred to dissolve the respective components, thereby preparing a matting agent solution.

| | | |
|---|---|---|
| Silica particle having an average | 2.0 | parts by mass |
| particle size of 20 nm (AEROSIL R972, | | |
| manufactured by Nippon Aerosil Co., Ltd.): | | |
| Methylene chloride: | 76.3 | parts by mass |
| Methanol: | 11.4 | parts by mass |
| Cellulose acetate solution 102: | 10.3 | parts by mass |

### (Fabrication)

The foregoing cellulose acetate solution, additive solution and matting agent dispersion were mixed in the following proportion to prepare a dope for fabrication and a dope for surface layer, respectively.

### (Preparation of Dope 102 for Fabrication)

The following composition was thrown into a mixing tank and stirred, and the respective components were adjusted so as to have a ratio as described later and mixed for dissolution, thereby preparing a dope for fabrication.

| | | |
|---|---|---|
| Cellulose acetate solution 101: | 91.5 | parts by mass |
| Additive solution 101: | 8.5 | parts by mass |

### (Preparation of Dope 102 for Surface Layer)

The following composition was thrown into a mixing tank and stirred, and the respective components were adjusted so as to have a ratio as described later and mixed for dissolution, thereby preparing a dope for surface layer.

| | | |
|---|---|---|
| Cellulose acetate solution 102: | 98.6 | parts by mass |
| Matting agent dispersion 102: | 1.4 | parts by mass |

### (Casting)

The foregoing dopes were cast by a co-casting method using a band casting machine such that the dope 102 for fabrication was a core layer and that the dope 102 for surface layer was a surface layer. The obtained web was stripped off from the band and laterally stretched in a stretch ratio of 20% under a condition at 130° C. by using a tenter; and after removing a clip, the resulting web was dried at 130° C. for 20 minutes to prepare a stretched cellulose acylate film sample 102 such that the core layer had a thickness after stretching of 74 μm and that the upper and lower surface layers each had a thickness after stretching of 3 μm. Each composition is shown in Table 1.

### Example 2

### Preparation of Cellulose Acylate Film Sample 103

### (Preparation of Additive Solution 103)

The following composition was thrown into a mixing tank and stirred to dissolve the respective components, thereby preparing an additive solution.

| | | |
|---|---|---|
| Illustrative Compound (104): | 10.0 | parts by mass |
| Methylene chloride: | 36.8 | parts by mass |
| Methanol: | 5.5 | parts by mass |
| Cellulose acetate solution 101: | 12.8 | parts by mass |

### (Fabrication)

The foregoing cellulose acetate solution and additive solution were mixed in the following proportion to prepare a dope for fabrication. The same dope as in the sample 102 was used as a dope for surface layer.

### (Preparation of Dope 103 for Fabrication)

The following composition was thrown into a mixing tank and stirred, and the respective components were adjusted so as to have a ratio as described later and mixed for dissolution, thereby preparing a dope for fabrication.

| | | |
|---|---|---|
| Cellulose acetate solution 101: | 91.5 | parts by mass |
| Additive solution 103: | 8.5 | parts by mass |

### (Casting)

The foregoing dope for fabrication was cast by a co-casting method using a band casting machine such that the dope 103 for fabrication was a core layer and that the dope 102 for surface layer as prepared in Example 1 was a surface layer. The obtained web was stripped off from the band and laterally stretched in a stretch ratio of 20% under a condition at 130° C. by using a tenter; and after removing a clip, the resulting web was dried at 130° C. for 20 minutes to prepare a stretched cellulose acylate film sample 103 such that the core layer had a thickness after stretching of 74 μm and that the upper and lower surface layers each had a thickness after stretching of 3 μm. Each composition is shown in Table 1.

### Example 3

### Preparation of Cellulose Acylate Film Sample 104

### (Fabrication)

The foregoing cellulose acetate solution and additive solution were mixed in the following proportion to prepare a dope for fabrication.

### (Preparation of Dope 104 for Fabrication)

The following composition was thrown into a mixing tank and stirred, and the respective components were adjusted so as to have a ratio as described later and mixed for dissolution, thereby preparing a dope for fabrication.

| | | |
|---|---|---|
| Cellulose acetate solution 101: | 93.7 | parts by mass |
| Additive solution 103: | 6.3 | parts by mass |

### (Casting)

The foregoing dope for fabrication was cast by a co-casting method using a band casting machine such that the dope 104 for fabrication was a core layer and that the dope 102 for surface layer as prepared in Example 1 was a surface layer. The obtained web was stripped off from the band and laterally stretched in a stretch ratio of 20% under a condition at 130° C. by using a tenter; and after removing a clip, the resulting web was dried at 130° C. for 20 minutes to prepare a stretched cellulose acylate film sample 104 such that the core layer had a thickness after stretching of 74 μm and that the upper and lower surface layers each had a thickness after stretching of 3 μm. Each composition is shown in Table 1.

### Example 4

### Preparation of Cellulose Acylate Film Sample 105

### (Preparation of Additive Solution 105)

The following composition was thrown into a mixing tank and stirred to dissolve the respective components, thereby preparing an additive solution.

| | | |
|---|---|---|
| Illustrative Compound (100): | 10.0 | parts by mass |
| Methylene chloride: | 36.8 | parts by mass |
| Methanol: | 5.5 | parts by mass |
| Cellulose acetate solution 101: | 12.8 | parts by mass |

### (Fabrication)

The foregoing cellulose acetate solution and additive solution were mixed in the following proportion to prepare a dope for fabrication.

### (Preparation of Dope 105 for Fabrication)

The following composition was thrown into a mixing tank and stirred, and the respective components were adjusted so as to have a ratio as described later and mixed for dissolution, thereby preparing a dope for fabrication.

| | | |
|---|---|---|
| Cellulose acetate solution 101: | 93.4 | parts by mass |
| Additive solution 105: | 6.6 | parts by mass |

### (Casting)

The foregoing dope for fabrication was cast by a co-casting method using a band casting machine such that the dope 105 for fabrication was a core layer and that the dope 102 for surface layer as prepared in Example 1 was a surface layer. The obtained web was stripped off from the band and laterally stretched in a stretch ratio of 20% under a condition at 130° C. by using a tenter; and after removing a clip, the resulting web was dried at 130° C. for 20 minutes to prepare a stretched cellulose acylate film sample 105 such that the core layer had a thickness after stretching of 70 μm and that the upper and lower surface layers each had a thickness after stretching of 5 μm. Each composition is shown in Table 1.

### Example 5

### Preparation of Cellulose Acylate Film Sample 106

### (Preparation of Cellulose Acetate Solution 103)

The following composition was thrown into a mixing tank and stirred to dissolve the respective components, thereby preparing a cellulose acetate solution.

| | | |
|---|---|---|
| Cellulose acetate (substitution degree: 2.91): | 100.0 | parts by mass |
| Triphenyl phosphate: | 4.3 | parts by mass |
| Biphenyl phosphate: | 3.0 | parts by mass |
| Methylene chloride: | 366.5 | parts by mass |
| Methanol: | 54.8 | parts by mass |

### (Preparation of Matting Agent Dispersion 103)

The following composition was thrown into a dispersing machine and stirred to dissolve the respective components, thereby preparing a matting agent solution.

| | | |
|---|---|---|
| Silica particle having an average | 2.0 | parts by mass |
| particle size of 20 nm (AEROSIL R972, | | |
| manufactured by Nippon Aerosil Co., Ltd.): | | |
| Methylene chloride: | 76.3 | parts by mass |
| Methanol: | 11.4 | parts by mass |
| Cellulose acetate solution 103: | 10.3 | parts by mass |

### (Preparation of Additive Solution 106)

The following composition was thrown into a mixing tank and stirred to dissolve the respective components, thereby preparing an additive solution.

| | | |
|---|---|---|
| Illustrative Compound (112): | 10.0 | parts by mass |
| Methylene chloride: | 36.8 | parts by mass |
| Methanol: | 5.5 | parts by mass |
| Cellulose acetate solution 103: | 12.8 | parts by mass |

### (Fabrication)

The foregoing cellulose acetate solution, additive solution and matting agent dispersion were mixed in the following proportion to prepare a dope for fabrication and a dope for surface layer, respectively.

### (Preparation of Dope 106 for Fabrication)

The following composition was thrown into a mixing tank and stirred, and the respective components were adjusted so as to have a ratio as described later and mixed for dissolution, thereby preparing a dope for fabrication.

| | | |
|---|---|---|
| Cellulose acetate solution 103: | 93.4 | parts by mass |
| Additive solution 106: | 6.6 | parts by mass |

### (Preparation of Dope 103 for Surface Layer)

The following composition was thrown into a mixing tank and stirred, and the respective components were adjusted so as to have a ratio as described later and mixed for dissolution, thereby preparing a dope for surface layer.

| | | |
|---|---|---|
| Cellulose acetate solution 103: | 98.6 | parts by mass |
| Matting agent dispersion 103: | 1.4 | parts by mass |

### (Casting)

The foregoing dopes were cast by a co-casting method using a band casting machine such that the dope 106 for fabrication was a core layer and that the dope 103 for surface layer was a surface layer. The obtained web was stripped off from the band and laterally stretched in a stretch ratio of 27% under a condition at 130° C. by using a tenter; and after removing a clip, the resulting web was dried at 130° C. for 20 minutes to prepare a stretched cellulose acylate film sample 106 such that the core layer had a thickness after stretching of 35 μm and that the upper and lower surface layers had a thickness after stretching of 13 μm and 3 μm, respectively. Each composition is shown in Table 1.

### <Concentration of Inorganic Particle in Film Surface Layer>

A concentration of the inorganic particle in the film surface layer of each of the samples 100 to 106 was measured in the foregoing method. As a result, it was noted that in the samples 102 to 106 of Examples 1 to 5 which are the optical compensation film of the invention, the concentration of the inorganic particle in the film surface layer was explicitly larger than the average concentration of the inorganic particle in the film. On the other hand, in the samples 100 and 101 of Comparative Examples 1 and 2, it was noted that the average concentration of the inorganic particle in the film was substantially equal to the concentration of the inorganic particle in the film surface layer.

### <Liquid Crystal Developability of Crystalline Compound Single Body>

The Illustrative Compounds (112), (104) and (100) as used in the film preparation examples of the invention are a liquid crystalline compound and had a liquid crystal phase-developing temperature Tm and an isotropic phase developing-temperature Tiso as described below.

Illustrative Compound (112): Tm=210° C., Tiso=253° C.

Illustrative Compound (104): Tm=160° C., Tiso=208° C.

Illustrative Compound (100): Tm=131° C., Tiso=230° C.

### <Haze of Film>

A haze of the cellulose acylate film sample of the invention having a size of 40 mm×80 mm was measured at 25° C. and 60% RH by using a haze meter (HGM-2DP, manufactured by Suga Test Instruments Co., Ltd.) in conformity with JIS K-6714. The measurement results are shown in Table 1.

### <Retardation of Film>

The measurement of three-dimensional birefringence was carried out at a wavelength of 446 nm, 548 nm and 628 nm, respectively in the foregoing method by using an automatic birefringence meter, KOBRA 21ADH (manufactured by Oji Scientific Instruments), thereby determining a retardation Rth in a film thickness direction as obtained by measuring Re while varying an in-plane retardation Re and an angle of inclination. Re and Rth at each of the wavelengths are shown in Table 1.

TABLE 1

| | Item | Unit | Sample 100 | Sample 101 | Sample 102 | Sample 103 |
|---|---|---|---|---|---|---|
| Core layer | Substitution degree of cellulose acetate | — | 2.79 | 2.86 | 2.86 | 2.86 |
| | Illustrative Compound (112) | wt % * | — | 7 | 7.5 | — |
| | Illustrative Compound (104) | wt % * | — | — | — | 7.5 |
| | Illustrative Compound (100) | wt % * | — | — | — | — |
| | Illustrative Compound (I-2) | wt % * | 7.5 | 2 | 2.2 | 2.2 |
| | Illustrative Compound (8) of formula (a) | wt % * | — | — | — | — |
| | Triphenyl phosphate | wt % * | 6.3 | 6.3 | 6.3 | 6.3 |
| | Biphenyl phosphate | wt % * | 5 | 5 | 5 | 5 |
| | R972 | wt % * | 0.15 | 0.15 | — | — |
| | Film thickness | μm | 80 | 80 | 74 | 74 |
| Surface layer | Substitution degree of cellulose acetate | — | — | — | 2.86 | 2.86 |
| | Triphenyl phosphate | wt % * | — | — | 6.3 | 6.3 |
| | Biphenyl phosphate | wt % * | — | — | 5 | 5 |
| | R972 | wt % * | — | — | 0.15 | 0.15 |
| | Film thickness of upper layer | μm | — | — | 3 | 3 |
| | Film thickness of lower layer | μm | — | — | 3 | 3 |
| Lateral stretch ratio | | % | 25 | 20 | 20 | 20 |
| Haze | | % | 0.6 | 3.5 | 0.5 | 0.6 |
| Re | (446 nm) | nm | 61 | 82 | 83 | 81 |
| | (548 nm) | nm | 58 | 100 | 101 | 100 |
| | (628 nm) | nm | 57 | 116 | 116 | 114 |
| Rth | (446 nm) | nm | 203 | 104 | 105 | 103 |
| | (548 nm) | nm | 195 | 126 | 127 | 125 |
| | (628 nm) | nm | 194 | 145 | 145 | 144 |
| Expression (a2) | Nz | — | 3.9 | 1.8 | 1.8 | 1.8 |
| Expression (a3) | Re(446)/Re(548) | — | 1.05 | 0.82 | 0.82 | 0.81 |
| Expression (a4) | Re(628)/Re(548) | — | 0.98 | 1.16 | 1.15 | 1.14 |
| Expression (a5) | Rth(446)/Rth(548) | — | 1.04 | 0.83 | 0.83 | 0.82 |
| Expression (a6) | Rth(628)/Rth(548) | — | 0.99 | 1.15 | 1.14 | 1.15 |

| Measured concentration of inorganic particle in film surface layer | wt % * | 0.15 | 0.15 | 0.14 | 0.14 |
|---|---|---|---|---|---|
| Measured average concentration of inorganic particle in film | wt % * | 0.15 | 0.15 | 0.01 | 0.01 |
| Remark | | Comparison | Comparison | Invention | Invention |

| | Item | Unit | Sample 104 | Sample 105 | Sample 106 |
|---|---|---|---|---|---|
| Core layer | Substitution degree of cellulose acetate | — | 2.86 | 2.86 | 2.94 |
| | Illustrative Compound (112) | wt % * | — | — | 6 |
| | Illustrative Compound (104) | wt % * | 5.4 | — | — |
| | Illustrative Compound (100) | wt % * | — | 5.7 | — |
| | Illustrative Compound (I-2) | wt % * | 2.2 | 2 | — |
| | Illustrative Compound (8) of formula (a) | wt % * | — | — | 5 |
| | Triphenyl phosphate | wt % * | 6.3 | 6.3 | 3.1 |
| | Biphenyl phosphate | wt % * | 5 | 5 | 2.2 |
| | R972 | wt % * | — | — | — |
| | Film thickness | μm | 74 | 70 | 45 |
| Surface layer | Substitution degree of cellulose acetate | — | 2.86 | 2.86 | 2.94 |
| | Triphenyl phosphate | wt % * | 6.3 | 6.3 | 3.1 |
| | Biphenyl phosphate | wt % * | 5 | 5 | 2.2 |
| | R972 | wt % * | 0.15 | 0.15 | 0.15 |
| | Film thickness of upper layer | μm | 3 | 5 | 13 |
| | Film thickness of lower layer | μm | 3 | 5 | 2 |
| Lateral stretch ratio | | % | 20 | 20 | 27 |
| Haze | | % | 0.7 | 0.5 | 0.5 |
| Re | (446 nm) | nm | 63 | 65 | 84 |
| | (548 nm) | nm | 81 | 82 | 102 |
| | (628 nm) | nm | 94 | 93 | 116 |
| Rth | (446 nm) | nm | 80 | 81 | 106 |
| | (548 nm) | nm | 96 | 98 | 127 |
| | (628 nm) | nm | 110 | 113 | 144 |
| Expression (a2) | Nz | — | 1.7 | 1.7 | 1.8 |
| Expression (a3) | Re(446)/Re(548) | — | 0.78 | 0.79 | 0.82 |
| Expression (a4) | Re(628)/Re(548) | — | 1.16 | 1.13 | 1.14 |
| Expression (a5) | Rth(446)/Rth(548) | — | 0.83 | 0.83 | 0.83 |
| Expression (a6) | Rth(628)/Rth(548) | — | 1.15 | 1.15 | 1.13 |

| Measured concentration of inorganic particle in film surface layer | wt % * | 0.14 | 0.15 | 0.15 |
|---|---|---|---|---|
| Measured average concentration of inorganic particle in film | wt % * | 0.01 | 0.02 | 0.04 |
| Remark | | Invention | Invention | Invention |

It is noted from the foregoing table that the comparative sample 100 is not satisfied with the expressions (a3) to (a6), whereas the samples 101 to 106 are a sample which is satisfied with all of the expressions (a1) to (a6).

As described later, in a liquid crystal display device provided with such an optical compensation film is improved with respect to the front contrast and the performance of color shift.

Furthermore, it is noted that the samples 102 to 106 which are the optical compensation film of the invention are low in haze of film and preferable as compared with the comparative optical compensation film sample 101.

### [Preparation of Polarizing Plate Samples 100 to 106]

The surface of each of the above-prepared cellulose acylate film samples 100 to 106 was subjected to an alkali saponification treatment. Each of the resulting samples was immersed in a 1.5 N sodium hydroxide aqueous solution at 55° C. for 2 minutes, washed in a water washing bath at room temperature and then neutralized with 0.1 N sulfuric acid at 30° C. The thus treated sample was again washed in a water washing bath at room temperature and then dried with warm air at 100° C. Subsequently, a rolled polyvinyl alcohol film having a thickness of 80 μm was continuously stretched in a stretch ratio of 5 in an iodine aqueous solution and then dried to obtain a polarizing film having a thickness of 20 μm. Each of the foregoing alkali-saponified polymer films and FUJITAC TD80UL (manufactured by Fujifilm Corporation) which had been subjected to an alkali saponification treatment in the same manner were prepared and stuck each other by using a 3% aqueous solution of polyvinyl alcohol (PVA-117H, manufactured by Kuraray Co., Ltd.) as an adhesive while interposing the polarizing film therebetween in such a manner that these saponified surfaces were faced on the polarizing film side. There were thus obtained polarizing plates 100 to 106 in which each of the cellulose acylate film samples was formed as a first optically anisotropic layer and TD80UL was formed as a passivation film of the polarizing film. On that occasion, sticking was achieved such that the MD direction of each of the cellulose acylate films and the slow axis of TD80UL were parallel to the absorption axis of the polarizing film.

### [Preparation of Film 201 for Second Optically Anisotropic Layer]

A cellulose acetate solution was prepared by mixing respective components in a proportion as described below. The cellulose acetate solution was cast by using a band casting machine. The obtained web was stripped off from the band and dried to prepare an 80 μm-thick cellulose acylate film 201 having the following composition.

| | |
|---|---|
| Cellulose acylate film (substitution degree: | 100 wt % |
| 2.92): | |
| Rth reducing agent as described below: | 11.3 wt % |
| Illustrative Compound I-(2): | 7 wt % |

Rth reducing agent

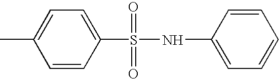

With respect to the foregoing film, the measurement of three-dimensional birefringence was carried out at a wavelength of 446 nm, 548 nm and 628 nm, respectively in the foregoing method by using an automatic birefringence meter, KOBRA 21ADH (manufactured by Oji Scientific Instruments), thereby determining a retardation Rth in a film thickness direction as obtained by measuring Re while varying an in-plane retardation Re and an angle of inclination. As a result, Re(446), Re(548) and Re(628) were 5 nm, 4 nm and 4 nm, respectively; and Rth(446), Rth(548) and Rth(628) were 103 nm, 100 nm and 97 nm, respectively. That is, it is noted that the film 201 is satisfied with all of the foregoing expressions (b1) and (b2).

### [Preparation of Polarizing Plate 201]

The surface of the above-prepared sample 201 was subjected to an alkali saponification treatment. The resulting film was immersed in a 1.5 N sodium hydroxide aqueous solution at 55° C. for 2 minutes, washed in a water washing bath at room temperature and then neutralized with 0.1 N sulfuric acid at 30° C. The thus treated film was again washed in a water washing bath at room temperature and then dried with warm air at 100° C. Subsequently, a rolled polyvinyl alcohol film having a thickness of 80 μm was continuously stretched in a stretch ratio of 5 in an iodine aqueous solution and then dried to obtain a polarizing film having a thickness of 20 μm. The foregoing alkali-saponified sample 201 and FUJITAC TD80UL which had been subjected to an alkali saponification treatment in the same manner were prepared and stuck each other by using a 3% aqueous solution of polyvinyl alcohol (PVA-117H, manufactured by Kuraray Co., Ltd.) as an adhesive while interposing the polarizing film therebetween in such a manner that these saponified surfaces were faced on the polarizing film side. There was thus obtained a polarizing plate 201 in which the sample 201 was formed as a second optically anisotropic layer and TD80UL was formed as a passivation film of the polarizing film. On that occasion, sticking was achieved such that the MD direction of the sample 201 and the slow axis of TD80UL were parallel to the absorption axis of the polarizing film.

### [Preparation of Liquid Crystal Display Devices 300 to 306]

In the configuration as illustrated in FIG. 2, each of the foregoing polarizing plates 100 to 106 was disposed as P1 such that each of the samples 100 to 106 was located on the VA liquid crystal cell side, namely at the position of 14 of FIG. 2; and the foregoing polarizing plate 201 was disposed as P2 such that the film 201 was located on the VA liquid crystal cell side, namely at the position of 15 of FIG. 2. There were thus prepared liquid crystal display devices 300 to 306. A liquid crystal television set of a VA mode (LC37-GE2, manufactured by Sharp Corporation) from which a polarizing plate and a retardation plate on the back and front thereof had been stripped off was used as the VA liquid crystal cell.

Sticking was achieved such that in P1, the slow axis of each of the samples 100 to 106 was orthogonal to the absorption axis of the polarizing film.

### [Evaluation of Liquid Crystal Display Device]

### (Evaluation of Tinting Viewing Angle of Panel)

With respect to each of the above-prepared VA mode liquid crystal display devices 300 to 306, backlight was placed on the side of the polarizing plate P1 in FIG. 2 (namely, the side of each of the polarizing plates 100 to 106); brightness and chromaticity at black displaying and white displaying in a dark room were measured by using an analyzer (EZ-Contrast XL88, manufactured by ELDIM); and the color shift and contrast at black displaying were calculated.

### (Black Color Shift in Polar Angle Direction)

At black displaying, it is preferable that when the viewing angle is inclined from the normal direction of the liquid crystal cell to the center line direction of the transmission axis of a pair of the polarizing plates (angle of azimuth: 45 degrees), changes Δx_{θ} and Δy_{θ} are always satisfied with the following numerical expressions (λ) and (Y).

0≦Δx_{θ}≦0.1 Numeral expression (X)

0≦Δy_{θ}≦0.1 Numeral expression (Y)

In the expressions, Δx_{θ}=x_{θ}−x_{θ0} and Δy_{θ}=y_{θ}−y_{θ0}; (x_{θ0}, y_{θ0}) is a chromaticity as measured in the normal direction of the liquid crystal cell at black displaying; and (x_{θ}, y_{θ}) is a chromaticity as measured in a direction inclined at a polar angle of θ degrees from the normal direction of the liquid crystal cell at black displaying to the center line direction of the transmission axis of a pair of the polarizing plates.

Results were evaluated according to the following criteria and shown in Table 2.

A: Both Δx_{θ} and Δy_{θ} are always not more than 0.02 at a polar angle of from 0 to 80 degrees.

B: Both Δx_{θ} and Δy_{θ} are always not more than 0.05 at a polar angle of from 0 to 80 degrees.

C: Both Δx_{θ} and Aye are always 0.1 or more at a polar angle of from 0 to 80 degrees.

### (Front Contrast)

A front contrast was calculated from (brightness at white displaying)/(brightness at black displaying) and evaluated according to the following criteria.

A: The front contrast is 2,000 or more.

B: The front contrast is 1,000 or more and less than 2,000.

C: The front contrast is less than 1,000.

TABLE 2

| | | | | | | | |
|---|---|---|---|---|---|---|---|
| Liquid crystal display device | 300 | 301 | 302 | 303 | 304 | 305 | 306 |
| Polarizing plate on backlight side | 100 | 101 | 102 | 103 | 104 | 105 | 106 |
| Polarizing plate on display surface | 201 | 201 | 201 | 201 | 201 | 201 | 201 |
| Black color shift | C | A | A | A | B | B | A |
| Contrast | C | C | A | A | B | B | A |
| Remark | Comparison | Comparison | Invention | Invention | Invention | Invention | Invention |

It is noted from Table 2 that the liquid crystal display devices 302 to 306 using the samples 102 to 106 of the invention, respectively are explicitly improved with respect to display characteristics such that they are largely improved with respect to the color shift as compared with the liquid crystal display device 300 using the comparative sample 100 and enhanced with respect the contrast as compared with the liquid crystal display device 301 using the comparative sample 101.

This application is based on Japanese Patent application JP 2007-12423, filed Jan. 23, 2007, and Japanese Patent application JP 2007-68581, filed Mar. 16, 2007, the entire contents of which are hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. An optical compensation film with optically biaxial properties, wherein the longer the wavelength is, the larger the wavelength dispersion of a retardation Re in an in-plane direction and a retardation Rth in a thickness direction against light in a visible light region is; the film contains at least one inorganic particle; a concentration of the inorganic particle in a film surface layer is from 0.05% to 1.0%; an average concentration of the inorganic particle in the film is from 0.01% to 0.3%; and the concentration of the inorganic particle in the surface layer is larger than the average concentration of the inorganic particle in the film.

2. The optical compensation film according to claim 1, which contains at least one compound represented by the following formula (I): 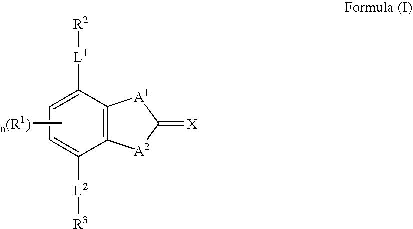
wherein L¹ and L² each independently represents a single bond or a divalent connecting group; A¹ and A² each independently represents a group selected from the group consisting of —O—, —NR—, —S— and —CO—, in which R represents a hydrogen atom or a substituent; R¹, R² and R³ each independently represents a substituent; X represents a non-metal atom belonging to the group 14 to the group 16 of a periodic table, and a hydrogen atom or a substituent may be bound to X; and n represents an integer of from 0 to 2.

3. The optical compensation film according to claim 1, which comprises a cellulose acylate.

4. The optical compensation film according to claim 1, wherein the inorganic particle includes a silicon dioxide particle.

5. The optical compensation film according to claim 2, wherein the optical compensation film is satisfied with the following expressions (a1) to (a6):
Re(548)>20 nm Expression (a1)
0.5<Nz<10 Expression (a2)
Re(446)/Re(548)≦1 Expression (a3)
1≦Re(628)/Re(548) Expression (a4)
Rth(446)/Rth(548)≦1 Expression (a5)
1≦Rth(628)/Rth(548) Expression (a6)
wherein Re(λ) and Rth(λ) represent a retardation (unit: nm) in an in-plane direction and a retardation (unit: nm) in a thickness direction, respectively as measured when light having a wavelength of λ nm is made incident; and Nz=Rth(548)/Re(548)+0.5.

6. The optical compensation film according to claim 1, wherein the optical compensation film is a film formed by a co-casting method using a dope for surface layer and a dope for core layer and simultaneously extruding a surface layer, a core layer and a surface layer, and a concentration of the inorganic particle in the dope for surface layer is larger than a concentration of the inorganic particle in the dope for core layer.

7. The optical compensation film according to claim 1, wherein the optical compensation film is a stack film formed by using a dope for surface layer and a dope for core layer and successively casting them to stack and form a surface layer, a core layer and a surface layer, and a concentration of the inorganic particle in the dope for surface layer is larger than a concentration of the inorganic particle in the dope for core layer.

8. The optical compensation film according to claim 6, wherein a compound represented by the following formula (I) is contained in the dope for core layer: 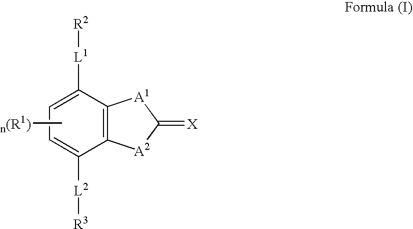
wherein L¹ and L² each independently represents a single bond or a divalent connecting group; A¹ and A² each independently represents a group selected from the group consisting of —O—, —NR—, —S— and —CO—, in which R represents a hydrogen atom or a substituent; R¹, R² and R³ each independently represents a substituent; X represents a non-metal atom belonging to the group 14 to the group 16 of a periodic table, and a hydrogen atom or a substituent may be bound to X; and n represents an integer of from 0 to 2.

9. A polarizing plate comprising the optical compensation film according to claim 1.

10. A liquid crystal display device comprising: a pair of first and second polarizers; a liquid crystal cell disposed between the pair of polarizers; and the optical compensation film according to claim 1 disposed between the first polarizer and the liquid crystal cell.

11. The liquid crystal display device according to claim 10, further comprising an optically anisotropic layer which is satisfied with the following expressions (b1) and (b2):

|Rth(548)/Re(548)|>10 Expression (b1)
Rth(628)−Rth(446)<0 Expression (b2)

12. The liquid crystal display device according to claim 10, wherein the liquid crystal cell is a liquid crystal cell of a vertically aligned mode.
